(19) United States
(12) Patent Application Publication
(10) Pub. No.: US 2017/0293874 A1
(43) Pub. Date: Oct. 12, 2017

(54) INTELLIGENT REAL-TIME 360° ENTERPRISE PERFORMANCE MANAGEMENT METHOD AND SYSTEM

(71) Applicant: Samir Asaf, Mine Hill, NJ (US)

(72) Inventor: Samir Asaf, Mine Hill, NJ (US)

(21) Appl. No.: 15/096,404

(22) Filed: Apr. 12, 2016

(51) Int. Cl. G06Q 10/06; G06N 3/04

(52) U.S. Cl. CPC G06Q 10/0637; G06Q 10/06393; G06N 3/0436

(57) ABSTRACT

An intelligent real-time 360° enterprise performance management system and 6-step methodology, which provides an integrated way to evaluate the performance and effectiveness of specific ‘business components’ within organizations (e.g., internal functions, internal processes, and stakeholder relationships). The system serves as a highly scalable, customizable, and context-aware Unified Enterprise Performance Management Application Platform (UEPMAP) that automates static and dynamic real-time and asynchronous business intelligence gathering from employees, customers, suppliers, business partners and other key stakeholders; analyses structured and unstructured feedback data; identifies strengths and weaknesses for each business component by way of SWOT analysis; develops prioritized action plans, supported by an adaptive neuro-fuzzy inference system (ANFIS) in order to address weaknesses identified within business components.

### COPYRIGHT NOTICE

A portion of the disclosure of this patent document contains material that is subject to copyright protection. The copyright owner has no objection to the facsimile reproduction by anyone of the patent documenter the patent disclosure, as it appears in the Patent and Trademark Office patent file or records, but otherwise reserves all copyright rights whatsoever. The following notice applies to any software and data as described below, and in the drawings hereto: Copyright ©2016, Performax Inc., All Rights Reserved.

### TECHNICAL FIELDS

The present invention relates generally to business performance management, and more particularly to a system and method for evaluating a company's performance by business component (internal functions, stakeholder groups, and internal processes); based on the identification, assessment, decomposition, and mapping of contextually relevant Critical Success Factors (CSFs). In addition, the present invention relates to collaboratively preparing performance reports and related action plans by engaging employees, customers, and internal and external stakeholders in providing 360 degree feedback and insights on the specific survey assessment areas or business components.

Collaborative Business Intelligence (CBI) is enabled by real-time ongoing assessor feedback, supported by best practices databases, a Context-Aware Intelligent Recommendation System (CAIRS) which uses best practices and expert decision-rules, to provide recommendations and alerts to expert panel members and assessors during the feedback design and submission process, A Real-Time Collaboration Hub (RTCH) provides a real-time platform for expert panel members and assessors to collaborate with each other and reach consensus on the effectiveness of CSFs and recommended Ideas for Action (IFAs); and Stakeholder Sentiment Analysis is applied to assessor feedback, using un-structured data analysis and Natural Language Processing (SSA-NLP) with deep learning methodology to identify the overall sentiment polarity of textual feedback received from different assessor groups.

Assessors provide feedback on the effectiveness of selected CSFs, and also recommend IFAs and KPIs for implementation. Based on the assessor feedback data, CSFs are categorized into strengths and weaknesses for the business component being assessed, and IFAs are selected for implementation; this is accomplished by nominating individuals to an ‘expert panel for action planning’ that collaboratively reviews the assessment results, and is supported by an Adaptive Neuro-Fuzzy Inference System (ANFIS) that analyzes the assessor feedback data and prioritizes which Ideas for Action (IFAs) ought to be implemented to maximize the effectiveness of the CSFs within selected business component. IFAs are selected for implementation by executive management, and Key Persons Accountable (KPAs) are assigned to each IFA, in order to enhance CSF effectiveness ratings. The nominated KPA and his/her team members undertake actions in order to implement the IFA, and these actions are communicated to the assessors, who in turn, update the CSF effectiveness ratings over time. Multi-period assessor feedback data is thus collected in real-time, and CSF effectiveness ratings are updated over time, allowing CSF effectiveness trend charts to be reported in a real-time basis.

### BACKGROUND OF THE INVENTION

Knowledge-based decision-making underpins every successful organization. Senior business managers entrusted with making strategic and operational decisions for the business engage their teams, consultants, etc., and are supported by research and data in order to reach decisions. However, human decision-making is inherently biased due to various factors leading to over-confidence: these include hindsight-bias, anchoring, framing, availability heuristic, confirmation bias, commitment escalation, etc. In order to overcome these biases and make objective decisions, some experts recommend seeking diverse outside opinion to counter our over-confidence.ⁱ In order to support such objective decision-making within an organizational context, 360 degree feedback systems may be particularly well-suited.

Effective managerial decision-making has a direct impact on business performance and results. Business Performance Management (BPM), also known as Enterprise Performance Management (EPM), relates to the effective execution and monitoring of the strategies and plans of a company's business. While each organization develops and implements an EPM system that suits its unique requirements, it is imperative for the organization to view its performance both at an aggregate level, and also at a more granular level, e.g., by business component (division, segment, geography, product-line, etc.). Typically, businesses operate based on a hierarchical organizational structure that starts with the Board of Directors at the top, headed by the Chairman, responsible for the overall corporate governance and strategic oversight functions. The Chief Executive Officer (CEO) reports to the Board of Directors, and is responsible for the overall operations and management functions; and reporting to the CEO, there are several lines-of-business or ‘Internal Functions’ headed by the respective CXOs.

Business components such as internal functions typically include Finance & Accounting, Sales & Marketing, Human Resource Management, Information Technology, Customer Service, Supply Chain Management, Operations & Fulfilment, Internal Audit & Risk, etc. Each internal function typically has its employees, strategies, analysis requirements, goals, Key Performance Indicators (KPIs), action plans, and Critical Success Factors (CSFs). In order for the overall organization to perform well and to achieve revenue and profit targets, it is imperative that each of its business components and internal functions perform effectively on its respective CSFs.

Within each business component (e.g., internal function or internal process), there are five (5) key performance ‘contexts’ that may be assessed, in order to address the core performance areas. These performance contexts include: (a) People & Leadership; (b) Analytics & Insights; (c) Strategy & Planning; (d) Execution & Process; (e) Performance & Results;

People & Leadership context: the prime mover for subsequent development and execution of strategies and plans; CSFs within this context that relate to the people side of the performance equation, include motivation, leadership skills, soft-skills such as communication skills, organizational values, training and development, talent management, integrity and ethics, commitment, empowerment, innovation, organizational culture, etc.

Analytics & Insights context: a key context for the performance of any business component, because data analytics are needed to understand current performance and identify areas of improvement. CSFs within this context may include: data analysis skills and competencies, analytics tools and software resources, industry-specific analytical skills, etc.

The Strategy & Planning context: a key context for each business component, because each internal function needs to develop a ‘functional strategy’ that is aligned to the overall organizational strategy. Similarly, each internal process or stakeholder group needs to be guided by relevant strategies and plans. CSFs within this context may include: strategic planning skills, strategy development processes, initiative and KPI identification, employee collaboration and engagement, customer engagement, innovation skills and processes, partnerships and business alliances, etc.

Execution & Process context: relates to the project management skills within each business component. This context ensures that the strategies and plans that have been developed for internal functions, internal processes, or stakeholder groups are effectively implemented. CSFs within this context may include: project planning skills, project management tools and software, identification of KPIs, ensuring cross-functional collaboration, etc.

The Performance & Results context: has to do with results delivery against goals and targets, which is required for each business component. CSFs within this context may include results reporting, variance analysis, dynamic action planning, issue-escalation to senior management, relationships with key stakeholders, risk management, cross-functional collaboration, etc. Since each internal function has annual and potentially multi-year goals and targets for delivering results, CSFs need to be identified and their effectiveness assessed, in order to ensure delivery of expected functional results.

Using an intelligent 360 degree feedback real-time assessment process for key business components, an organization can gather and decompose dynamic and collaborative insights on functional effectiveness, identify key strengths and weaknesses, and collaboratively develop contextually relevant action plans, supported by deep learning technologies, sentiment analysis, and context-aware intelligent recommendation systems.

Each business component carries-out a number of tasks that are part of core business processes or that support business processes. In addition to evaluating the performance of specific business components, such as internal ‘functions’, it is also useful to assess the effectiveness of key business ‘processes’ that drive functional results. Each business component may have several business processes comprising its respective tasks and activities. For example, under the Finance & Accounting Function, an organization may have a specifically identified set of business processes. e.g., Treasury Management Process, Cost Management Process, Internal Audit Process, Financial Risk Management Process, etc.

Under the Sales & Marketing Function, key processes may include Sales Effectiveness Process, Customer Lifecycle Management Process, Sales Distribution Strategy Process, etc. Certain business processes may be cross-functional in nature, that is, the processes cross functional boundaries and are sequentially or simultaneously worked-on by employees from multiple internal functions. Each identified business process has key internal stakeholders, and may also have external stakeholders who interface with the said process. Therefore, similar to business components, such as internal functions, the performance and effectiveness of business processes can be evaluated through 360 feedback and CBI on CSFs related to each business process. The performance and effectiveness assessment is based on five performance contexts: (a) People & Leadership, (b) Analytics & Insights, (c) Strategy & Planning, (d) Execution & Process, and (e) Performance & Results, thus delivering key insights on any effectiveness issues, and collaborative recommendations on the action plan(s). Using an intelligent 360 degree feedback assessment process for key business processes, an organization can gather and decompose dynamic and collaborative insights on process effectiveness, and collaboratively develop contextually relevant action plans.

Another business component is an organization's stakeholders. Each organization has both internal and external stakeholders that are relevant to the EPM process. Internal stakeholders include employees. Shareholders may be treated as internal or external stakeholders depending on how they are viewed. Other external stakeholders include regulators, customers, creditors, suppliers, business partners, competitors, community, etc. Organizations typically manage stakeholder relations through investor relations, marketing, corporate social responsibility initiatives, voice of employee surveys, voice of customer surveys, and public relations programs. However, the effectiveness with which an organization manages its key stakeholder relations is an important factor in overall EPM.

For each stakeholder group, an organization can identify CSFs such as skills, competencies, and resources that need to be focused on and continually improved. For example, one of the key stakeholder groups for an organization is its ‘customers’. For this stakeholder group, CSFs might include quality of products and services, quality of customer service, responsiveness level of the customer service team, customer issue resolution effectiveness process, etc. Using an intelligent 360 degree feedback assessment process for key stakeholder groups, an organization can gather and decompose dynamic and collaborative insights on stakeholder effectiveness, and collaboratively develop contextually relevant action plans.

‘360-Degree Feedback’ is a survey-based system or process in which employees receive confidential, anonymous feedback from the people who work around them. This typically includes the employee's manager, peers, and direct reports. Various employee performance assessment related questions are included in the survey questionnaire. The German military first began gathering feedback from multiple sources in order to evaluate performance during World War II.ⁱⁱ One of the earliest recorded uses of surveys to gather information about employees occurred in the 1950s at Esso Research and Engineering Company.ⁱⁱⁱ Typically, assessors are selected who have experience working with the subject employee, and are sent a questionnaire to which they submit their responses reflecting their opinion on the effectiveness of the subject employee. Several studies^{iv} indicate that the use of 360-degree feedback helps to improve employee performance because it helps the evaluated employees see different perspectives of their performance.

Despite the great benefits many 360 degree feedback systems (i.e., multi-rater assessments) provide for improving individual employee performance, these systems are only as powerful as the quality and consistency of assessor feedback data, and the analysis that is conducted on the such data, which comprises both structured data (performance or effectiveness ratings) and un-structured data (textual opinion feedback from assessors). Unfortunately, there is a disconnect in traditional 360 degree feedback systems and methods, and their ability to add value in enhancing employee and organizational performance.

Some researchers claim that the use of multi-rater assessments does not improve company performance. One 2001 study found that 360 degree feedback was associated with a 10.6 percent decrease in market value, and concludes that “there is no data showing that 360-degree feedback actually improves productivity, increases retention, decreases grievances, or is superior to forced ranking and standard performance appraisal systems.”^{v} The disconnect arises because traditional 360 feedback systems are static one-time feedback collection systems. They provide a ‘snapshot’ of performance effectiveness at a point in time, and thus are not dynamic real-time multi-period feedback systems. In addition, they do not enable assessors to collaborate with each other before submitting their feedback responses. They do not utilize expert systems with inherent intelligence, nor do they recommend Ideas for Action (IFAs) or Key Performance Indicators (KPIs). Assessors do not receive any guidance or incremental intelligence while providing their feedback, and their opinions [textual unstructured data] are typically not analyzed using Natural Language Processing (NLP) techniques such as Sentiment Analysis. In addition, traditional 360 degree feedback systems have not employed new technologies, such as, Adaptive Neural Fuzzy Inference Systems (ANFIS) (particularly suitable for analyzing opinions that may involve ‘degrees of agreement’ to assessment questions; i.e., are complex systems that involve inherent imprecision and uncertainty such as human reasoning and opinions) in order to facilitate the determination of actions to be taken to enhance CSF effectiveness within business components. Therefore, traditional 360 feedback systems have not leveraged the value of real-time assessor collaboration, real-time multi-period and asynchronous assessor feedback and real-time results reporting; intelligent recommendation technologies, fuzzy inference systems, and sentiment polarity analytics. Essentially, traditional 360 feedback systems reflect static feedback which renders them of limited value.

This disconnect becomes even more apparent when analyzing an organization's overall performance by ‘business component’, where 360 feedback systems have not been systematically used. Neither has this method been used to evaluate the effectiveness of business components, such as internal functions, internal processes, or stakeholder relationships. For example, when analyzing the performance and effectiveness of a business component, such as the Finance & Accounting function, organizations typically look at the functional KPIs and whether they were achieved. This provides only a partial and incomplete view of functional performance, as KPI data fail to provide insights into the causes of any under-performance or the actions that need to be undertaken in order to enhance performance. The lack of effectiveness of traditional 360 feedback systems drives organizations to rely on direct observation of performance results through KPIs, rather than implementing an intelligent 360 degree feedback system for business components.

While traditional 360 degree feedback systems have not been applied to evaluate the effectiveness of business components, such as functions and processes, it is a natural extension of its traditional application to individual employee effectiveness. However, it requires specific identification of Critical Success Factors (CSFs) for each business component (internal function or process) in order for an assessment instrument (questionnaire) to be developed for conducting the surveys for specific business components. In addition, suitable assessor groups and assessors need to be identified for each business component, who will provide value-added feedback in the process of evaluating the functional effectiveness. Assessment of the performance of specific business components such as internal functions and processes is therefore considerably more complicated than that for individual employees.

Companies attempt to solve this disconnect through the implementation of employee and customer engagement programs, voice of employee surveys, voice of customer surveys, employee opinion surveys, as well as quarterly or annual employee appraisals. Although these solutions are good at collecting valuable feedback and information on areas of improvement, they do not provide an integrated and collaborative viewpoint on organizational strengths and weaknesses, and action plans. Nor do they recommend multi-point solutions, utilizing best practices knowledge-bases, fuzzy logic, sentiment analysis, or intelligent recommendation technologies for key business components, thus limiting their contribution to sustainable performance improvements from an enterprise or business component perspective. Since traditional 360 feedback surveys do not incorporate real-time, ongoing, and asynchronous assessor feedback collection mechanisms, they are unable to demonstrate the impact of new business initiatives and projects on the relative performance of business components and related CSFs dynamically or in real-time.

Accordingly, there is a need for software tools and information technology solutions to create a unified, systematic, and real-time capability to drive organizational performance improvement strategy and value creation through 360 degree real-time collaborative business intelligence that accurately measures the key drivers of business component (functional, process, and stakeholder engagement) effectiveness from an objective multi-rater [multi-dimensional] perspective, as well as detail how these drivers interrelate, thus delivering actionable business intelligence, leveraging value-added tools such as sentiment analysis, intelligent recommendation technologies, fuzzy inference systems, real-time collaboration among assessors [feedback providers], and real-time performance tracking.

From that multi-dimensional perspective, in addition to evaluating the performance of individual employees, it is necessary to be able to extend such real-time 360 degree evaluation to business components (internal functions, internal processes, and stakeholder relationships) which should incorporate specific identification of CSFs, strengths and weaknesses, and recommendations of action plans that adequately address underperforming areas, while improving and further enhancing organizational strengths for competitive advantage. In addition, the assessment results must be communicated to the decision-makers in a transparent manner.

It should be appreciated by one of ordinary skill in the art that, while information technology has progressed significantly over the last 65 years since feedback surveys first began in 1950s, traditional 360 feedback systems have remained fixated on a static feedback process focused only on individual employee performance appraisals. Consequently, a large majority of organizational performance areas, namely, business components (internal functions, processes, and stakeholder relationship effectiveness) have remained outside the scope of 360 degree feedback assessments.

In addition, traditional 360 feedback systems have not benefited from application and integration of new technologies such as real-time asynchronous assessor feedback data collection, analysis, and reporting; or from Natural Language Processing (NLP) and sentiment analysis that began with machine learning algorithms in the 1980s, enabling analysis of unstructured [text feedback] data; and intelligent recommendation technologies such as Adaptive Neuro-Fuzzy Inference Systems (ANFIS) that began in the 1990s. See Jang, J.-S. R. (1993). “ANFIS: adaptive-network-based fuzzy inference system”. IEEE Transactions on Systems, Man and Cybernetics 23 (3). Traditional 360 feedback systems also failed to adopt dynamic collaboration tools such as real-time chat-rooms etc. for assessor collaboration (e.g., collaboration hubs powered by real-time chat functionality).

### SUMMARY OF THE INVENTION

In one embodiment, the invention includes a computer-implemented method for a Unified Enterprise Performance Management Application Platform (UEPMAP), comprising the intelligent 360 degree real-time feedback and action planning methodology for organizations, identifying key organizational challenges, and conducting a collaborative feedback assessment survey of key business components (e.g., internal functions, business processes, stakeholder groups) for evaluating the effectiveness of Critical Success Factors (CSFs); preparing a dynamic and real-time assessment report comprising identification of strengths and weaknesses, causes of any under-performance, and an action plan including KPI and IFA recommendations derived from both a best practices knowledgebase, and also from direct assessor feedback; utilizing a contextually relevant best-practices assessment questionnaire for the selected business component assessment area, e.g., an internal function or an internal process; nominating expert panel members to select the right assessors and assessor groups; supporting the assessors in their feedback process through a Context-Aware Intelligent Recommendation System (CAIRS) powered by ANFIS, RTCH, and SSA-NLP; utilizing an expert panel to evaluate the IFAs submitted by assessors, and collaboratively validating and recommending a suitable action plan to address the identified organizational challenges within selected business components; and tracking real-time CSF performance results, based on dynamic asynchronous updates to assessor inputs.

In another embodiment, the invention includes a computer-implemented method for the Unified Enterprise Performance Management Application Platform (UEPMAP), comprising the intelligent 360 degree real-time feedback and action planning methodology for organizations, identifying key organizational challenges, and conducting a collaborative feedback assessment survey of key internal and external stakeholders, e.g., employees, customers, and business partners, for evaluating of the effectiveness of critical success factors within key organizational functions, processes, and stakeholder relations; preparing a real-time dynamic assessment report comprising identification of strengths and weaknesses, causes of any under-performance, and an action plan including KPI recommendations derived from both a best practices database, and also from direct assessor feedback; customizing a contextually relevant best-practices assessment questionnaire for the selected assessment area, e.g., an internal function or an internal process by nominating an expert panel to design the assessment instrument questionnaire to reflect the organization's context and priorities; nominating expert panel members to select the right assessors and assessor groups; supporting the assessors in their feedback process through a CAIRS powered by ANFIS, RTCH, and SSA-NLP; and utilizing an expert panel to evaluate the IFAs submitted by assessors, and collaboratively validating and recommending a suitable action plan to address the identified organizational challenges within business components.

These and other embodiments and aspects of the invention are described with reference to the noted Figures and the below detailed description of the preferred embodiments.

### BRIEF DESCRIPTION OF THE DRAWINGS

FIG. 1 is a flowchart representative of the UEPMAP characterized by the Intelligent 360 Degree Real-Time Business Performance Assessment & Action Planning Process, and covers ‘user objectives’ and required ‘inputs’.

FIG. 2 is a continuation of FIG. 1, and is a flowchart representative of the UEPMAP characterized by the Intelligent 360 Degree Real-Time Business Performance Assessment & Action Planning Process, and covers the ‘process’ steps and ‘outputs’.

FIG. 3 is a continuation of FIGS. 1 and 2, and is a flowchart representative of the UEPMAP characterized by the Intelligent 360 Degree Real-Time Business Performance Assessment & Action Planning Process, and covers ‘action by owner’ and ‘tools’.

FIG. 4 is a flowchart representative of an exemplary architecture for step 1 of the UEPMAP system(Focus), which helps users select relevant assessments.

FIG. 5 is a flowchart representative of an exemplary architecture for step 2 of the UEPMAP system(Customize), which helps users customize the assessment questionnaire based on the organization's unique context, through a collaborative process.

FIG. 6 is a continuation of FIG. 5, and is an exemplary depiction of the Context-Aware Intelligent Recommendation System (CAIRS)—Assessment Design Wizard (ADW) algorithm, supporting the UEPMAP system.

FIG. 7 is a continuation of FIG. 5, and is a flowchart representative of an exemplary architecture for step 2 of the UEPMAP system (Customize), which helps users customize the assessment questionnaire based on the organization's unique context, through a collaborative process.

FIG. 8 is a continuation of FIG. 7, and is an exemplary depiction of the Context-Aware Intelligent Recommendation System (CAIRS)—Assessor Selection Wizard (ASW) algorithm, supporting the UEPMAP system.

FIG. 9 is a flowchart representative of an exemplary architecture for step 3 of the UEPMAP system (Engage), which helps users initiate and receive accurate feedback from nominated assessors.

FIG. 10 is a continuation of FIG. 9, and is an exemplary depiction of the Context-Aware Intelligent Recommendation System (CAIRS)—Assessor Feedback Wizard (AFW) algorithm, supporting the UEPMAP system.

FIG. 11 is a flowchart representative of an exemplary architecture for step 4 of the UEPMAP system (Evaluate), which helps users evaluate the assessment results and gain in-depth understanding of strengths and weaknesses of the selected business components.

FIG. 12 is a continuation of FIG. 11, and is an exemplary depiction of the Context-Aware Intelligent Recommendation System (CAIRS) Stakeholder Sentiment Analysis—Natural Language Processing (SSA-NLP) algorithm, supporting the UEPMAP system.

FIG. 13 is a flowchart representative of an exemplary architecture for step 5 of the UEPMAP system (Act), which helps users engage an expert panel to recommend an action plan.

FIG. 14 is a continuation of FIG. 13, and is an exemplary depiction of the Context-Aware Intelligent Recommendation System (CAIRS)—Action Planning Wizard (APW) algorithm, supporting the UEPMAP system.

FIG. 15 is a continuation of FIG. 14, and is an exemplary depiction of an Adaptive Neuro-Fuzzy Inference System—Action Planning Wizard (ANFIS-APW) algorithm, supporting the UEPMAP system.

FIG. 16 is a flowchart representative of an exemplary architecture for the Real-Time Collaboration Hub (RTCH), which enables expert panel members as well as assessors to interact in real-time and asynchronously, in order to determine their feedback to assessment questions, and dynamically update their feedback over time.

FIG. 17 is a diagram representative of an exemplary Open Source Architecture for the UEPMAP software.

FIG. 18 is a diagram representative of an exemplary Microsoft Technology Architecture for the UEPMAP software using .NET Technology, MySQL Database, and Microsoft Azure cloud services.

FIG. 19 is a diagram representative of an exemplary depiction of a real-time Critical Success Factor (CSF) Prioritization Matrix, which presents CSFs based on their priority for actions or required initiatives, and is dynamically updated based on real-time assessor input.

FIG. 20 is a diagram representative of an exemplary depiction of a real-time Critical Success Factor (CSF) SWOT (Strengths, Weaknesses, Opportunities, and Threats) Matrix, which classifies CSFs into Strengths, Weaknesses, Opportunities, or Threats, based on assessor feedback, and is dynamically updated based on real-time assessor input.

FIG. 21 is a flowchart representative of an exemplary depiction of a Systems Architecture View of the UEPMAP system, and its 5-step assessment implementation process, and the constituent inter-relationships and dependencies within and among the different systems components, and covers Step 1 (Focus) and Step 2 (Customize).

FIG. 22 is a continuation of FIG. 21, and is a flowchart representative of an exemplary depiction of a Systems Architecture View of the UEPMAP system, and its 5-step assessment process, and the constituent inter-relationships and dependencies within and among the different systems components, and covers Step 3 (Engage) and Step 4 (Evaluate), and Step 5 (Act).

### DETAILED DESCRIPTION OF THE INVENTION

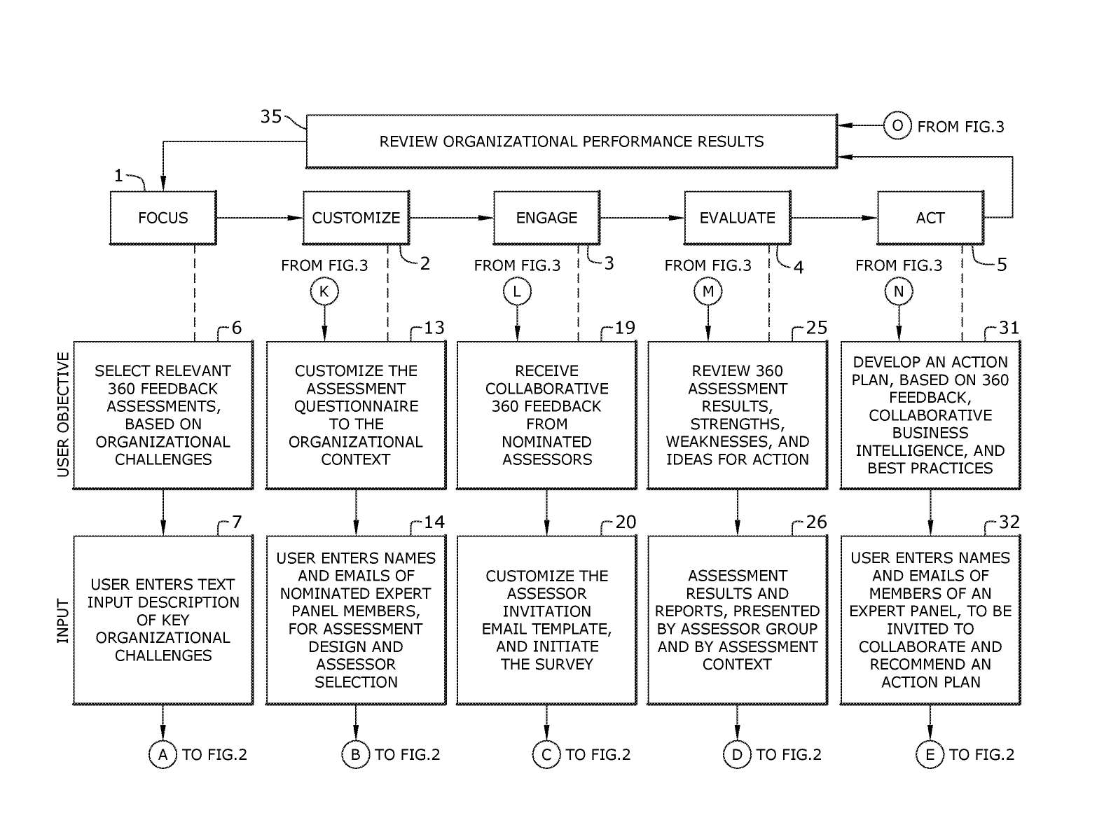

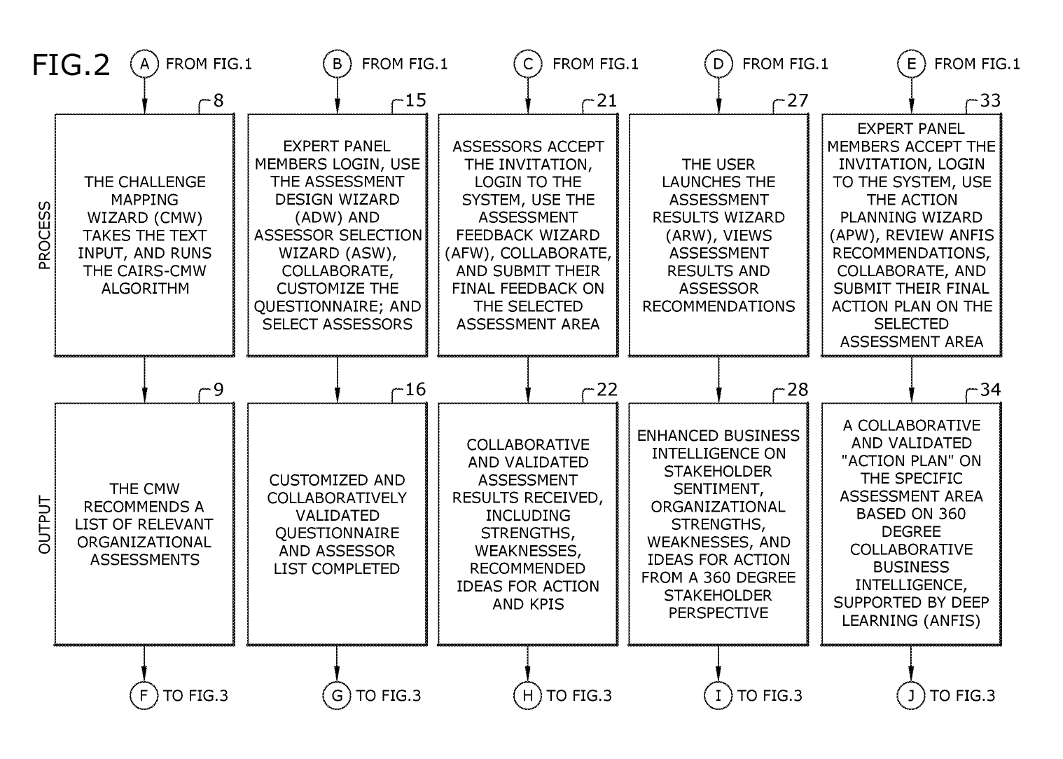

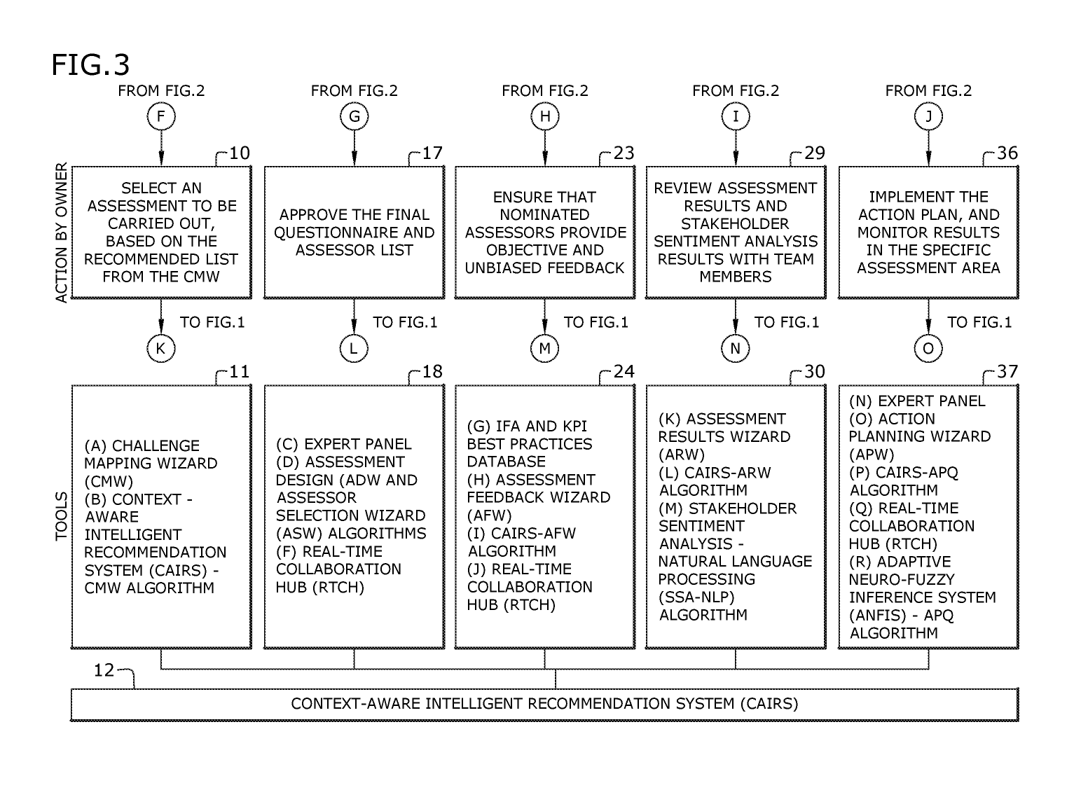

Referring now to the drawings, and initially to FIG. 1, FIG. 2, and FIG. 3, an exemplary system for implementing one embodiment, incorporating the intelligent real-time 360 degree business performance assessment and action planning process; the invention includes a systematic 5-step implementation process and framework for conducting organizational assessments. The first step in the assessment process is ‘Focus’ 1 in which the user has the objective 6 to select organizational assessments that are relevant to the organizational challenges. In order to accomplish this, the user inputs 7 text descriptions of the organizational challenges into the system using the challenge mapping wizard (CMW), which implements the Context-Aware Intelligent Recommendation System (CAIRS)-CMW algorithm process 8, in order to recommend relevant organizational assessments as the output 9. The action to be taken by the assessment ‘owner’ 10 is to view the recommended assessments and select one to be carried out. Tools 11 used in carrying out step 1 (Focus) include (a) challenge mapping wizard, and (b) CAIRS-CMW algorithm. The Context-Aware Intelligent Recommendation System (CAIRS) 11 is an expert system that recommends and alerts users on relevant issues throughout the assessment feedback process via the wizards, leveraging an intelligent rules database, user input data, and other technologies, e.g., ANFIS.

The second step in the assessment process is ‘Customize’ 2 in which the user has the objective 13 to customize the assessment questionnaire by using the assessment design wizard (ADW), and select the right assessor groups and assessors. In order to accomplish this, the user inputs 14 names and email addresses of the nominated expert panel members for assessment design and assessor selection, using the assessment design wizard (ADW) and the assessor selection wizard (ASW) respectively.

The process 15 involves the expert panel members accepting the invitation, logging-in to the system, collaborating with each other through the Real-Time Collaboration Hub (RTCH), and using the ADW and ASW to select the right assessment questions and assessors. The output 16 is a collaboratively developed and validated questionnaire and assessor list, which the assessment owner approves 17. Tools 18 used in this step include expert panels for assessment design and assessor selection, ADW and ASW, CAIRS-ADW and CAIRS-ASW algorithms, and the RTCH.

The third step in the assessment process is ‘Engage’ 3 in which the user has the objective 19 to receive collaborative and validated feedback from assessors by using the assessment feedback wizard (AFW), which enables assessors to update their feedback dynamically over-time. In order to accomplish this, the user inputs 20 an edited email invitation template for assessors, and initiates the survey. The process 21 involves the assessors accepting the invitation, logging-in to the system and submitting their feedback including their updates, over time, collaborating with each other through the Real-Time Collaboration Hub (RTCH), and using the AFW to submit their final collaborative feedback. The output 22 is a collaboratively submitted assessment result, including strengths, weaknesses, and ideas for action in the specific assessment area or business component. The assessment owner is to ensure that the nominated assessors provide objective and unbiased feedback 23 dynamically and over-time. Tools 24 used in this step include IFA and KPI best practices database, assessment feedback wizard (AFW), CAIRS-AFW algorithms, and the RTCH.

The fourth step in the assessment process is ‘Evaluate’ 4 in which the user has the objective 25 to review the assessment results using the assessment results wizard (ARW). In order to accomplish this, the user inputs 26 assessment results parameters such as results by assessor groups and by assessment context (e.g., people and leadership, analytics and insights, strategy and planning, execution and process, and performance and results). The process 27 involves the assessment owner/user utilizing the ARW in order to gain a multi-dimensional 360 degree] stakeholder perspective. The output 28 is deeper organizational and collaborative intelligence on the performance of the assessment area or business component. The assessment owner is to review assessment results with key team members 29. Tools 30 used in this step include the assessment results wizard (ARW), CAIRS-ARW algorithms, and Stakeholder Sentiment Analysis—Natural Language Processing (SSA-NLP) deep learning methodology.

The fifth and final step in the assessment process is ‘Act’ 5 in which the user has the objective 31 to invite an expert panel to develop an action plan, based on assessment results, using the action planning wizard (APW). In order to accomplish this, the user inputs 32 names and email addresses of members of an expert panel. The process 33 involves the expert panel members accepting the invitation, logging-in, using the APW and ANFIS recommendations, collaborating, and finalizing an action plan for the selected business component. The output 34 is a collaboratively developed action plan, supported by deep learning sentiment analysis, and intelligent ANFIS recommendation technologies, designed to improve the performance of the selected assessment area or business component. The assessment owner is to implement the recommended action plan 36. Tools 37 used in this step include an expert panel, action planning wizard (APW), CAIRS-APW algorithms, Real-Time Collaboration Hub (RTCH), and Adaptive Neuro-Fuzzy Inference System (ANFIS)-APW algorithm. Once the recommendations have been implemented, the user or assessment owner is to review organizational performance results in real-time in order to track performance improvements over-time 35, which is enabled by real-time assessor feedback functionality. In other words, the system login ID never expires for the nominated assessors who provide feedback, as well as the managers who track results. This allows the assessors to login anytime and update their original CSF ratings and text feedback dynamically, based on visible and tangible actions being undertaken by the organization to improve specific areas of the business (CSFs); thus managers can view the CSF effectiveness trends in the performance dashboard in real-time.

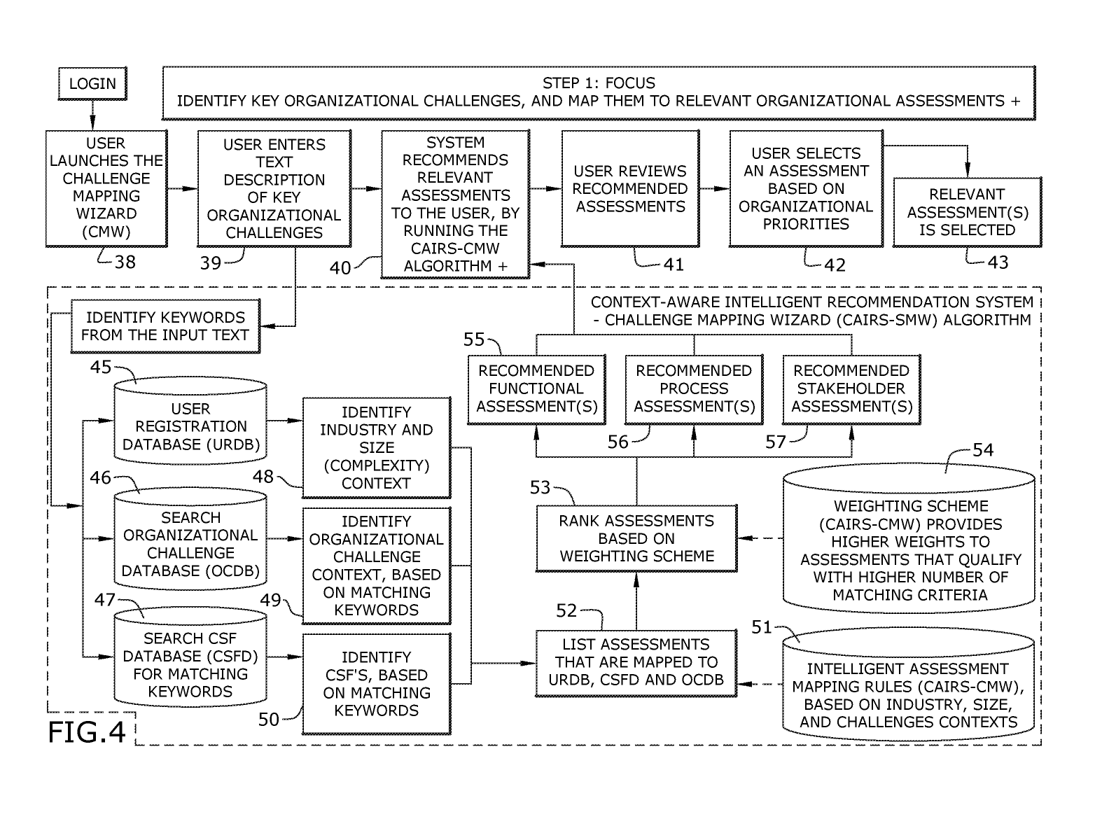

FIG. 4 is a flowchart representative of an exemplary architecture for step 1 of the UEPMAP system (Focus), which helps users identify relevant organizational assessments, given key organizational challenges, supported by the Context-Aware Intelligent Recommendation System (CAIRS)-CMW algorithm. After the user logs-in to the system, the user launches the challenge mapping wizard (CMW) 38, and enters text description of key organizational challenges 39. The system takes this text input and deploys the Context-Aware Intelligent Recommendation System (CAIRS)—CMW algorithm 40, which recommends appropriate organizational assessments for the organization 41, from which the user selects an assessment to be undertaken 42. The process ends with an assessment being selected by the user for implementation 43. The CAI RS-CMW algorithm starts with identification of keywords 44 from user input on organizational challenges 39. The system compares user text input against the User Registration Database (URDB) 45 which provides the industry and size contexts 48; Organizational Challenge Database (OCDB) 46 which helps map challenges to assessments 49; and Critical Success Factors Database (CSFD) 47 which maps CSFs to assessments 50. The algorithm performs text keyword mapping 52, utilizing intelligent assessment mapping rules 51, and ranks relevant assessments 53 using a weighting scheme 54 that places higher weights to assessments that qualify with a higher number of matching criteria. As a result, the CAIRS-CMW algorithm provides recommendations on functional assessments 55, process assessments 56, and stakeholder assessments 57.

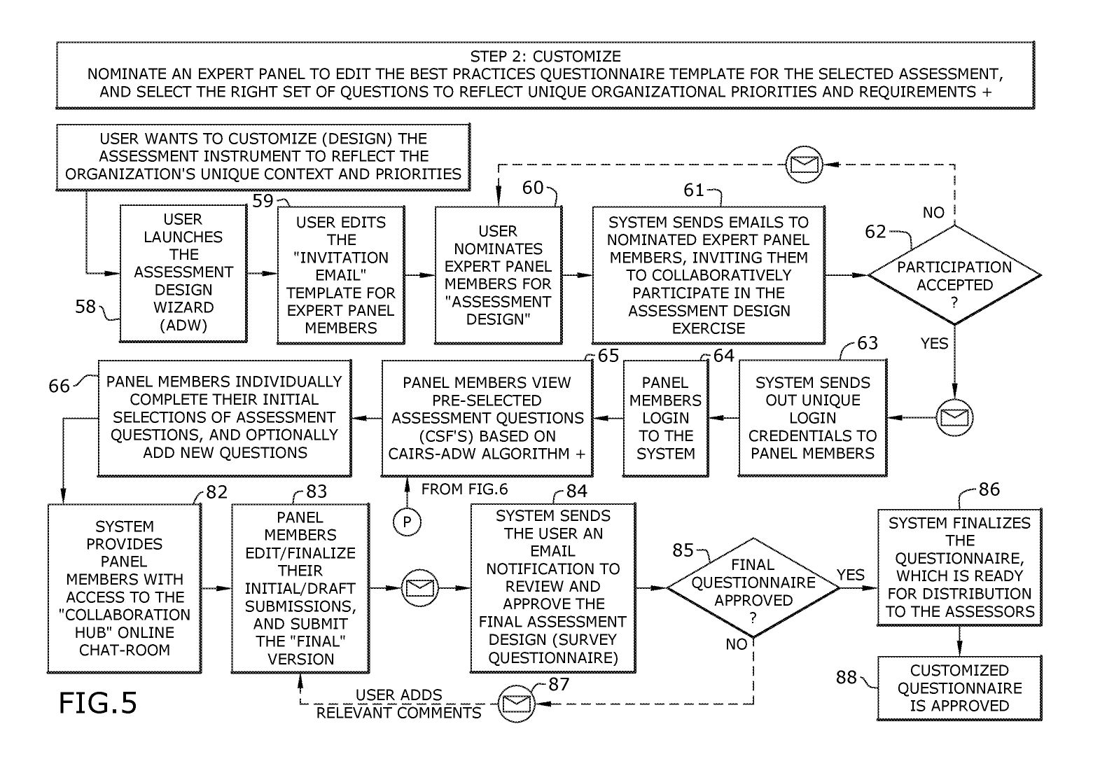

FIG. 5 is a flowchart representative of an exemplary architecture for step 2 of the UEPMAP system (Customize), which helps users customize the assessment questionnaire through a collaborative process, supported by the Context-Aware Intelligent Recommendation System (CAIRS)-ADW algorithm. We assume that, at this stage, the desired assessment to be undertaken has been selected by the user. The user launches the assessment design wizard (ADW) 58, edits the invitation email for expert panel members for assessment design 59, and nominates the expert panel members 60, after which the system sends invitation emails to the expert panel members 61, which is usually ‘accepted’ by the panel members. If not accepted 62, the user/owner is notified via email, and alternative panel members may be nominated. Once the nominated expert panel members accept the invitation, they are sent their unique login credentials 63, using which expert panel members login 64, and view pre-selected assessment questions 65 based on CAIRS-ADW algorithm. Expert panel members individually complete a draft version of their feedback 66, and subsequently are provided access to the Collaboration Hub 82, where panel members interact in real-time and asynchronously, regarding assessment question selection, etc. Now, panel members edit and finalize their assessment question selections 83, and the user/owner is sent a notification email 84 once all panel members have submitted their final versions. If the user approves the final version 85, the system finalizes the questionnaire for distribution to the nominated assessors 86, otherwise 87, the user adds relevant comments why the questionnaire is not approved, which goes back to the panel. Thus, the questionnaire is finalized and approved 88. On an on-going basis, the expert panel members can dynamically add new assessment questions for feedback from the assessors.

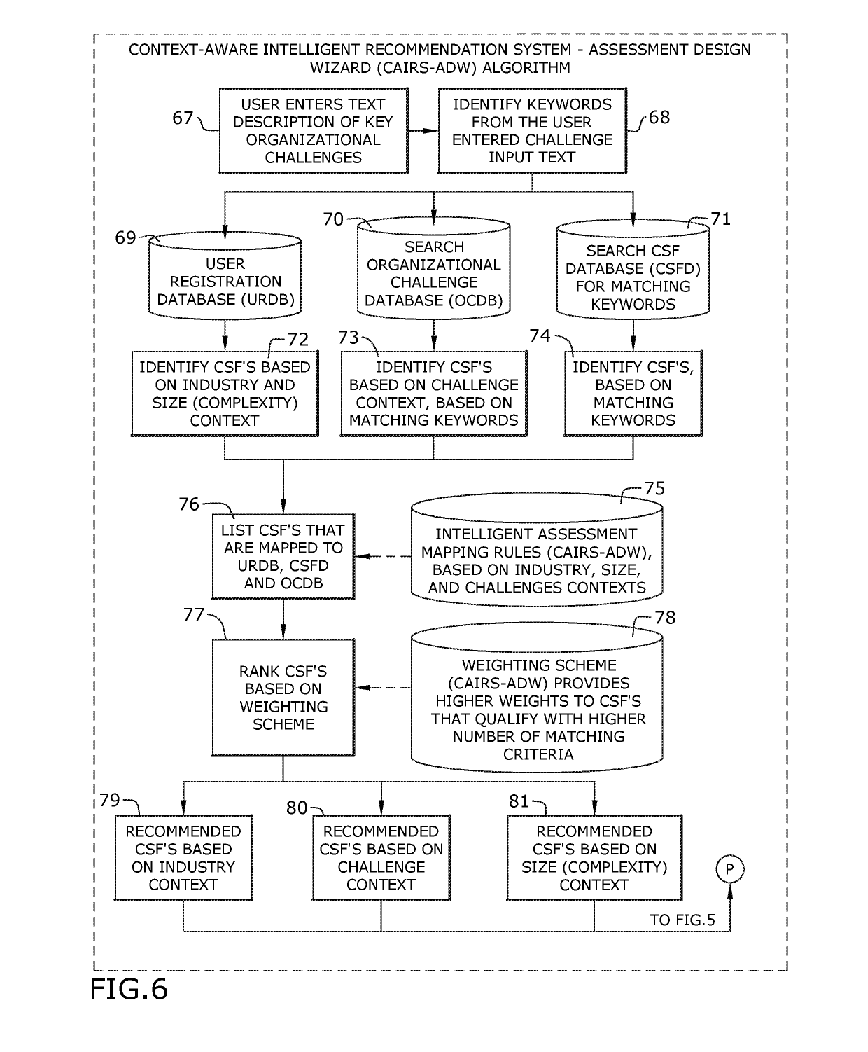

FIG. 6 is a continuation of FIG. 5, and a flowchart representative of an exemplary architecture for step 2 of the assessment process (Customize), which depicts the CAIRS-ADW algorithm; which starts with identification of keywords 68 from user input on organizational challenges 67. The system compares user text input against the User Registration Database (URDB) 69, which provides the industry and size contexts 72; Organizational Challenge Database (OCDB) 70, which helps map challenges to assessments 73; and Critical Success Factors Database (CSFD) 71 which maps CSFs to assessments 74. The algorithm performs text keyword mapping 76, utilizing intelligent assessment mapping rules 75, and ranks relevant CSFs 77 using a weighting scheme 78 that places higher weights to assessments that qualify with a higher number of matching criteria. As a result, the CAIRS-ADW algorithm provides recommendations on optimal CSF selection based on industry context 79, organizational challenge context 80, and organizational size/complexity context 81. The expert panel members can dynamically update the assessment design based on new organizational priorities.

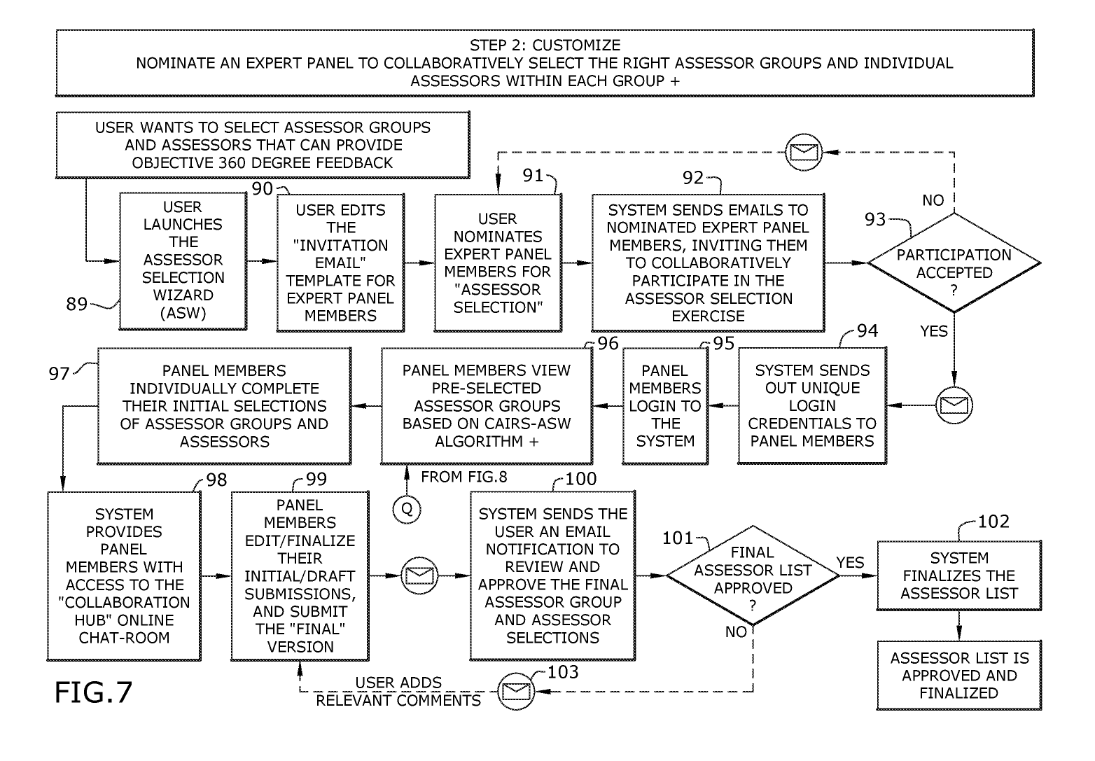

FIG. 7 is a flowchart representative of an exemplary architecture for step 2 of the UEPMAP system (Customize). This step helps users nominate an expert panel for selection of assessor groups and assessors, through a collaborative process, supported by the CAIRS-ASW algorithm. We assume that, at this stage, the desired assessment to be undertaken has been selected by the user (in step 1). The user launches the assessor selection wizard (ASW) 89, edits the invitation email for expert panel members for assessor selection 90, and nominates the panel members 91, after which the system sends invitation emails to the expert panel members 92, which is usually ‘accepted’ by the panel members. If not accepted 93, the user/owner is notified via email, and alternative panel members may be nominated.

Once the panel members accept the invitation, they are sent their unique login credentials 94, using which expert panel members login 95, and view pre-selected assessor groups 96 based on CAIRS-ASW algorithm. Panel members individually complete a draft version of their feedback 97, and subsequently are provided access to the Collaboration Hub 98, where panel members interact in real-time regarding assessment question selection, etc. Now, panel members edit and finalize their assessment question selections 99, and the user/owner is sent a notification email 100 once all panel members have submitted their final versions. If the user approves the final assessor groups and assessors in nominated by the expert panel 101, the system finalizes the assessor list for distribution 102, otherwise 103 user adds relevant comments why the assessor list is not approved, which goes back to the expert panel. Thus, the assessor group and assessor list are finalized and approved. On an ongoing basis, the expert panel members can revise their assessor group and assessor lists, and invite additional assessors to provide ongoing feedback on the critical success factors.

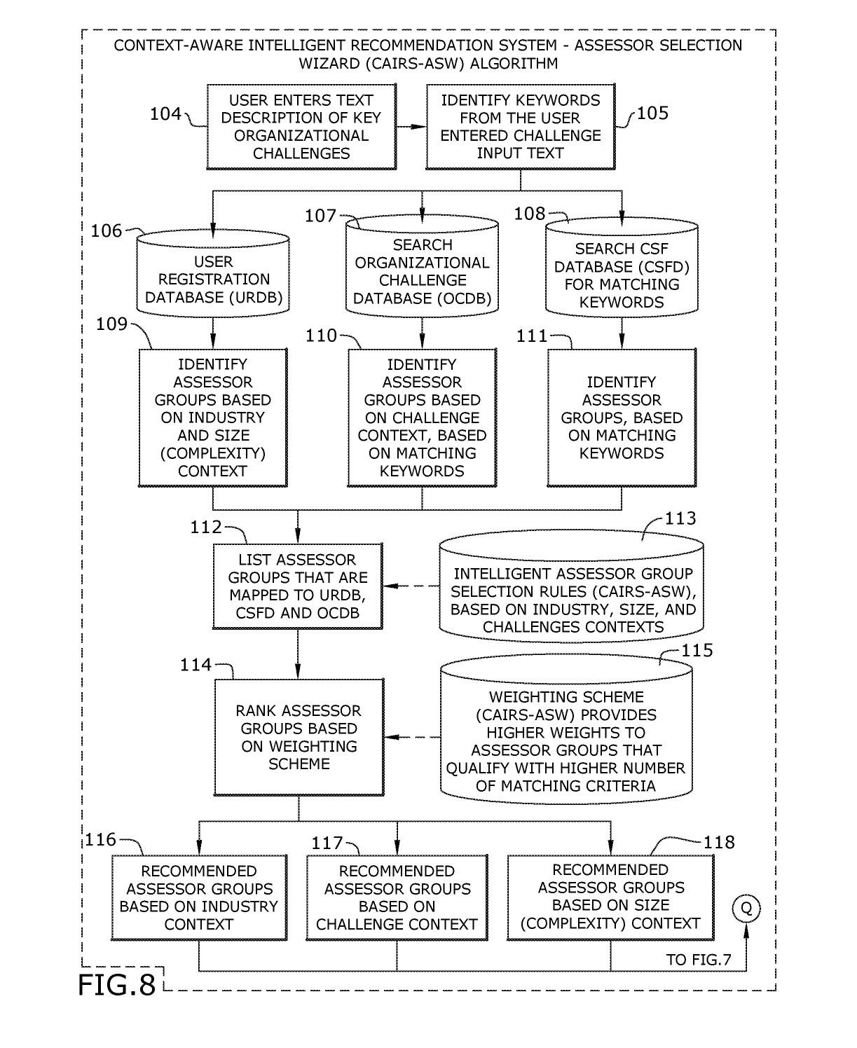

FIG. 8 is a continuation of FIG. 7, and is a flowchart representative of an exemplary architecture for step 2 of the UEPMAP system (Customize), depicting the CAIRS-ASW algorithm which starts with identification of keywords 105 from user input on organizational challenges 104. The system compares user text input 104 against the User Registration Database (URDB) 106, which identifies assessor groups based on size context 109; Organizational Challenge Database (OCDB) 107 identifies assessor groups based on organizational challenge context 110; and Critical Success Factors Database (CSFD) 108 maps CSFs to relevant assessor groups 111. The algorithm performs text keyword mapping, and lists recommended assessor groups 112, utilizing intelligent assessor group selection rules 113, and ranks relevant assessor groups 114 using a weighting scheme 115 that places higher weights to assessor groups that qualify with a higher number of matching criteria. As a result, the CAIRS-ASW algorithm provides recommendations on optimal assessor groups based on industry context 116, challenge context 117, and company size (complexity) context 118.

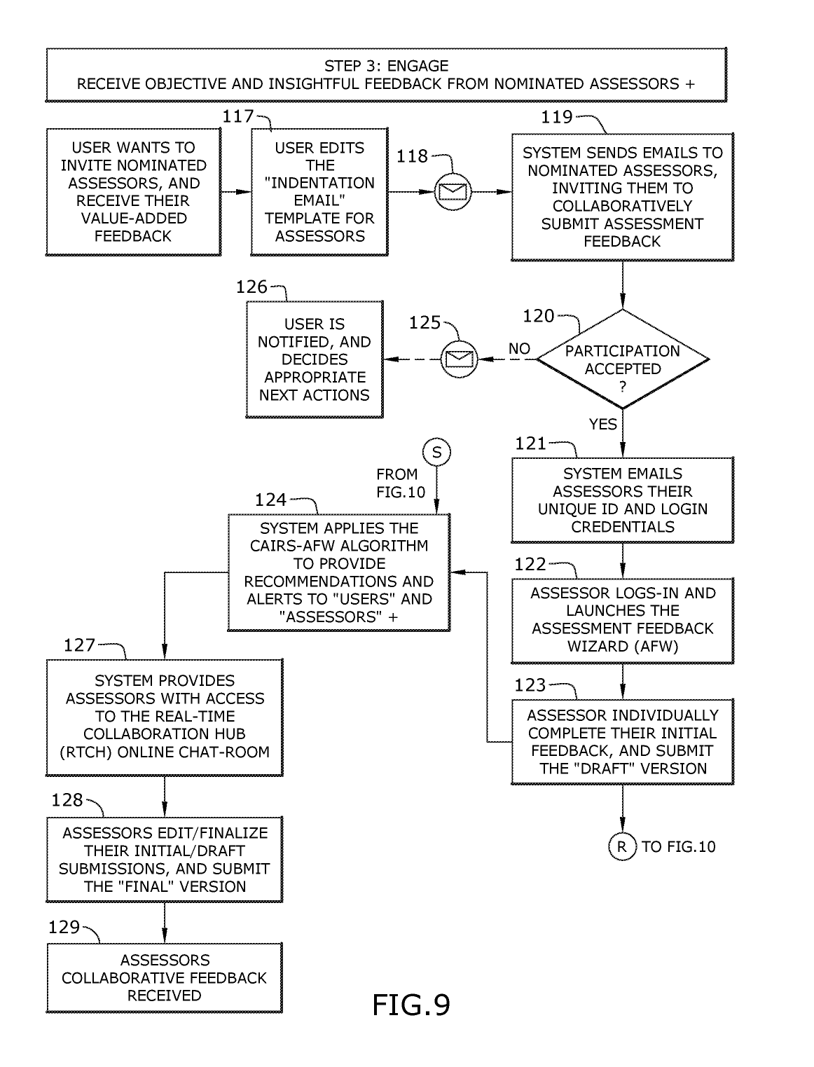

FIG. 9 is a flowchart representative of an exemplary architecture for step 3 of the UEPMAP system (Engage), which helps users initiate and receive real-time feedback from nominated assessors, supported by the Context-Aware Intelligent Recommendation System (CAIRS)-AFW algorithm. It is assumed that, at this stage, the assessment questionnaire and assessor list have been finalized and approved. The user edits the email invitation template for the assessors 117 and initiates the survey process, which sends emails 118 to the nominated assessors 119, which includes the option to accept or decline the invitation 120. If an assessor declines to provide feedback 125, the user is notified 126, otherwise, the assessor accepts the invitation, in which case the system sends the assessors their login credentials 121, with which the assessors login and launch the AFW 122, and individually complete their initial feedback via a draft version 123. This step is maintained in order to ensure that assessors have the first opportunity to provide their objective and unbiased opinion, before being exposed to the being influenced through the collaboration hub.

Once the assessors have submitted their ‘draft’ responses, the system applies the CAIRS-AFW algorithm 124 to provide ‘Recommendations’ and ‘Alerts’ to the assessors. The system provides assessors with access to the Real-Time Collaboration Hub (RTCH) online chat-room 127, where the assessors interact regarding assessment ratings, rationale, etc. They then have the option to edit their initial draft feedback 128 and submit the final version, thus participating in the collaborative feedback process 129, which is designed as an on-going and dynamic process enabling these assessors to update their feedback in response to visible organizational initiatives.

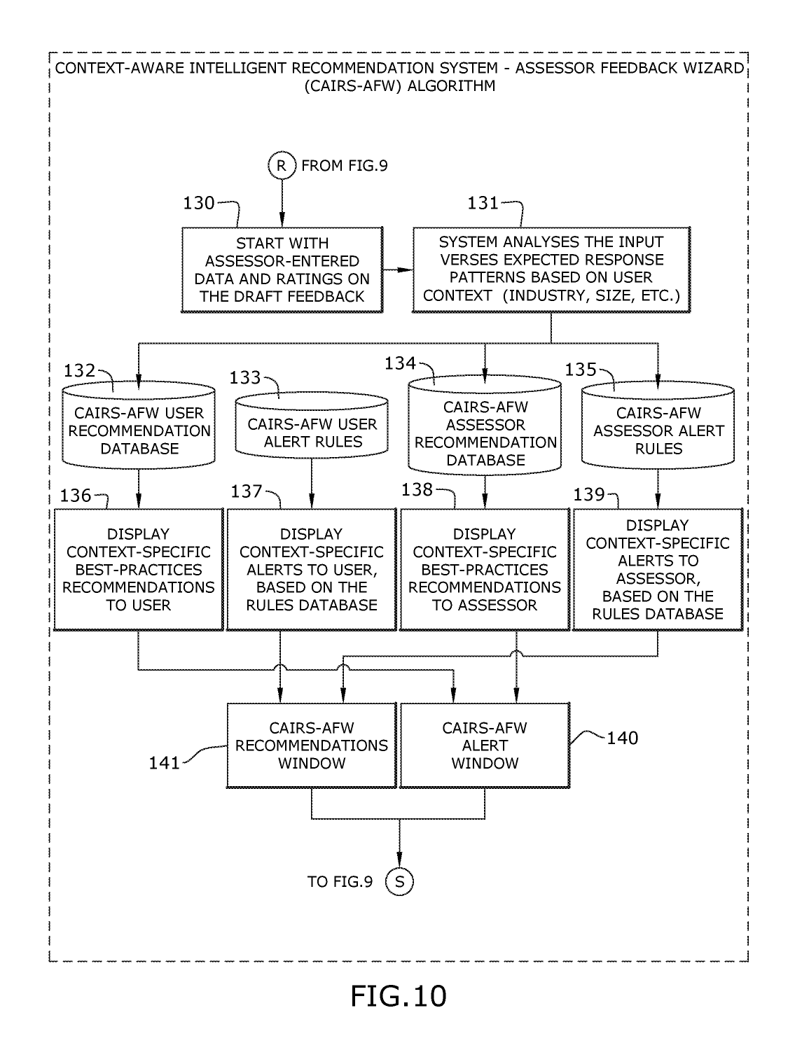

FIG. 10 is a continuation of FIG. 9, and is a flowchart that provides an exemplary depiction of the CAIRS-AFW algorithm, which starts with the assessor-entered data and ratings on the draft feedback 130. Subsequently, the system analyzes the inputs vs. expected response patterns based on user context (industry, size, etc.) 131, and provides context-specific recommendations 141 and rule-based alerts 140 to the user/owner of the assessment 136, 137, and to the assessors themselves 138, 139, based on the alert rules database 133, 135 and best practices recommendations database 132, 134.

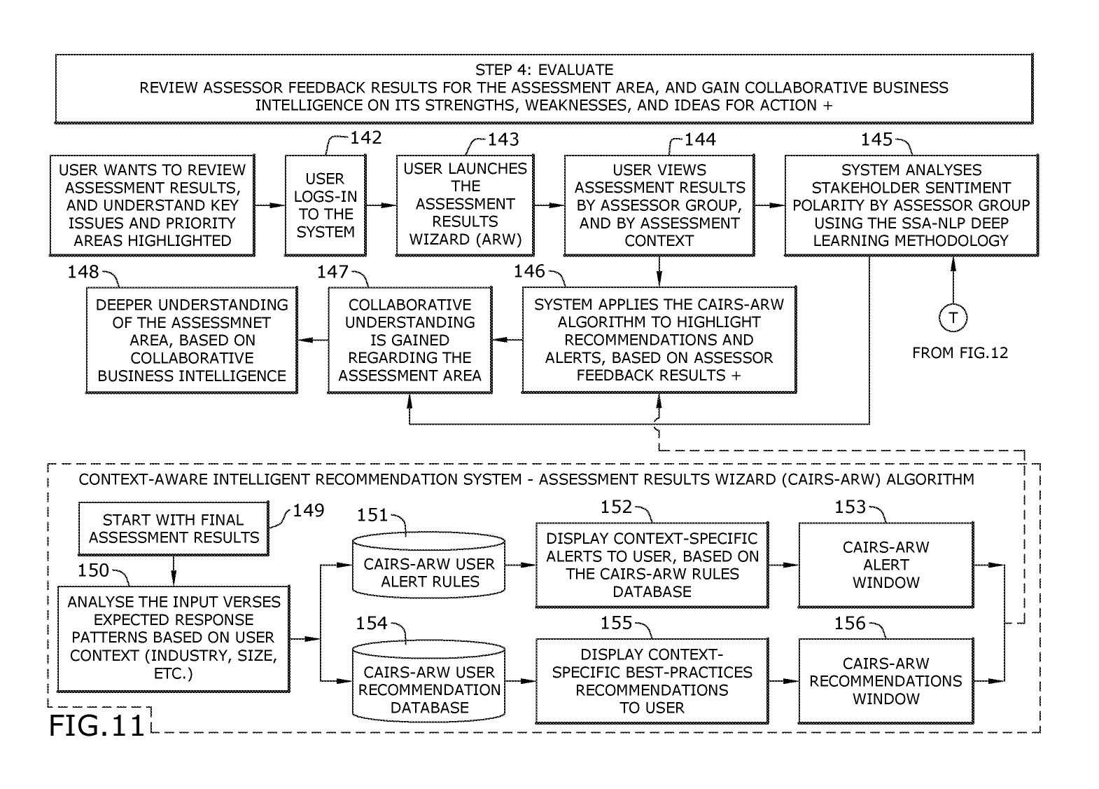

FIG. 11 is a flowchart representative of an exemplary architecture for step 4 of the UEPMAP system (Evaluate), which helps users dynamically evaluate the assessment results over time, and gain in-depth understanding of ‘strengths’, ‘weaknesses’, and ‘ideas for action’ in the selected assessment area, supported by the CAIRS-ARW algorithm, and SSA-NLP deep learning methodology. It is assumed that, at this stage, the assessors have collaboratively completed and submitted their real-time assessment feedback, and the user is interested to evaluate and gain an understanding of the feedback results, and how they change over-time. First, the user logs-in to the system 142, and launches the assessment results wizard (ARW) 143, and views results by assessor group (e.g., senior managers, mid-level managers, junior employees, customers, suppliers, etc.), and by assessment context (people and leadership, analytics and insights, strategy and planning, execution and process, and performance and results) 144.

The system also analyzes stakeholder sentiment polarity based on Natural Language Processing (SSA-NLP) technology and Deep Learning Methodology 145. The system applies the CAI RS-ARW algorithm, and provides Recommendations and Alerts 146 to the user. Based on these expert inputs from the system, the user gains collaborative understanding regarding the assessment area 147, 148. The Context-Aware Intelligent Recommendation System (CAIRS)-ARW algorithm starts with assessment results submission by assessors 149. The system analyses the inputs 150, and applies the CAIRS-ARW user alert rules 151 to display context-sensitive alerts to the user 152 in the CAIRS-ARW Alert window 153. In addition, the system also applies the CAI RS-ARW recommendations database 154 to display context-sensitive best practices recommendations to the user 155 in the CAIRS-ARW Recommendations window.

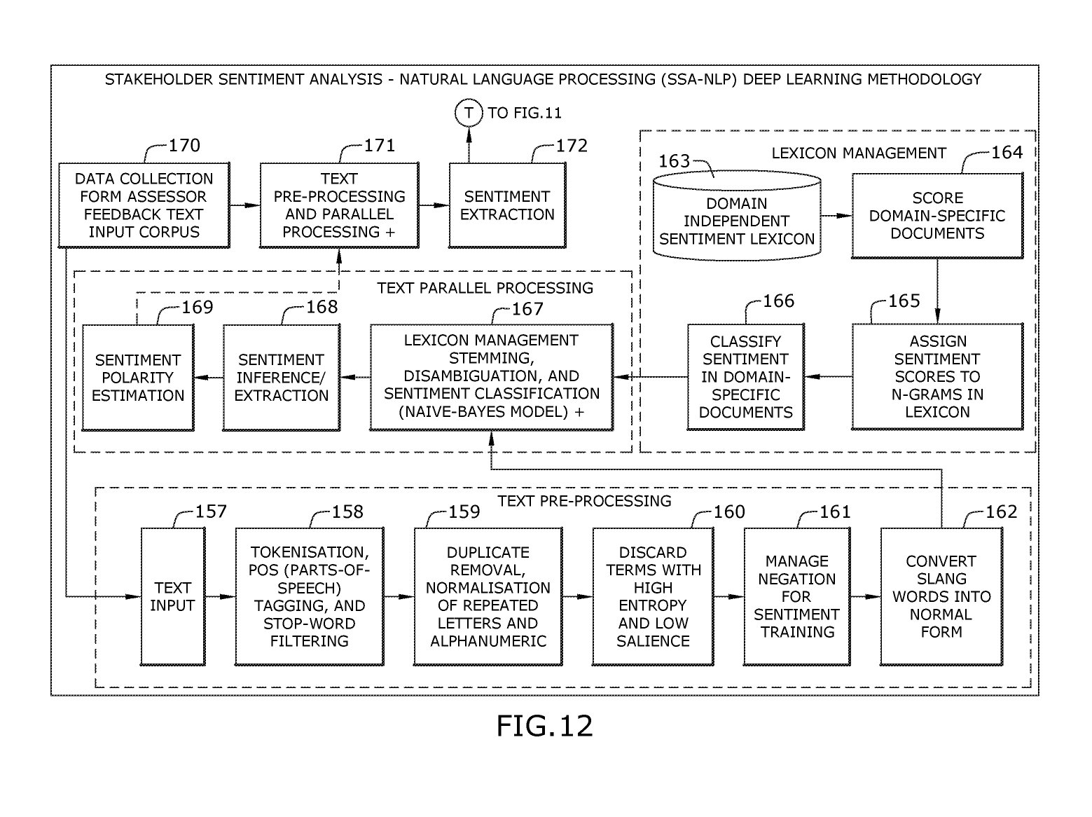

FIG. 12 is a flowchart that represents as exemplary depiction for a Stakeholder Sentiment Analysis—Natural Language Processing (SSA-NLP) Deep Learning Methodology, that starts with data collection from assessor feedback text input corpus 170, and performs text pre-processing 157-162. Text input 157 is pre-processed 158 by performing tokenization, parts-of-speech (POS) tagging, and stop-word filtering; after which duplicates are removed, repeated letters and alphanumeric inputs are normalized 159; terms that have high entropy and low salience are discarded 160; negation is managed for sentiment training 161; and any slang words are converted to normal form 162. Lexicon management 163-166: starts with building a domain independent sentiment lexicon 163, scoring domain-specific documents 164, assigning sentiment scores to N-grams in the lexicon 165, and classifying sentiment in domain-specific documents 166. Text Parallel Processing 167-169 is performed after text pre-processing is completed, with lexicon management, stemming, disambiguation, and sentiment classification (Naïve-Bayes Model) 167, based on which sentiment inference and extraction is performed 168, and sentiment polarity estimated 169. Text Pre-processing and Parallel-processing are completed 171, and final sentiment extraction (positive, negative, or neutral) for each CSF by assessor group is displayed 172, and is dynamically updated with new assessor input.

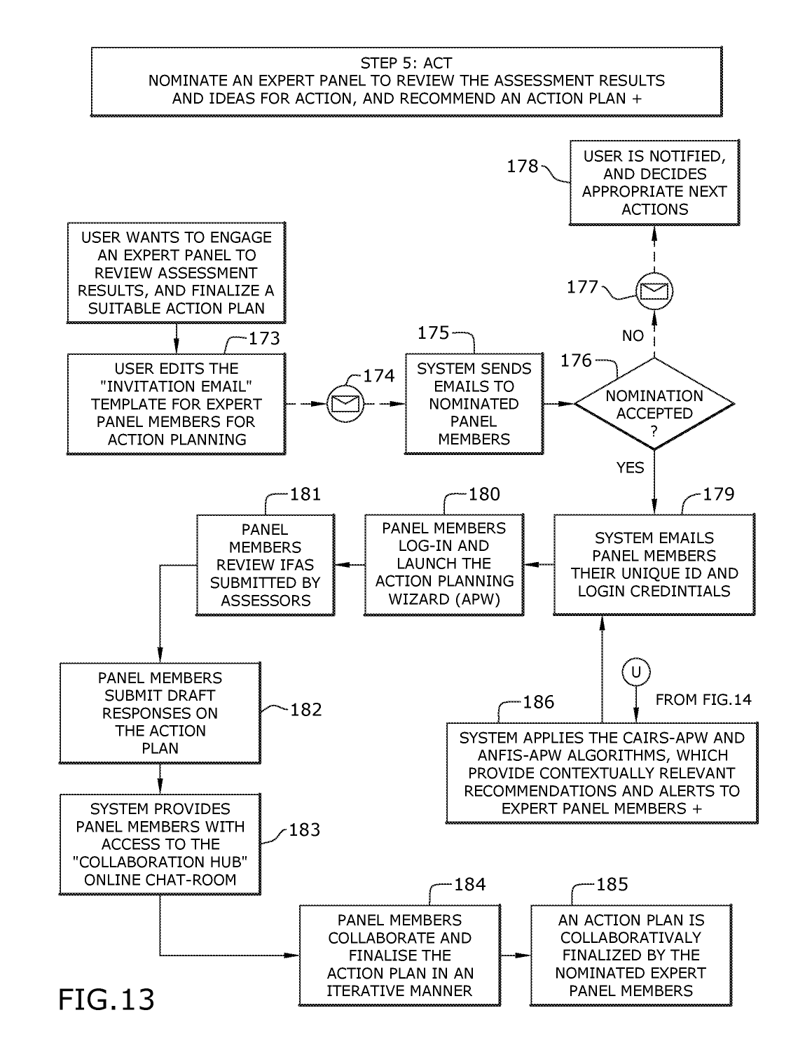

FIG. 13 is a flowchart representative of an exemplary architecture for step 5 of the UEPMAP system (Act), which helps users engage an expert panel to collaboratively recommend an action plan. The action plan is dynamically updated over-time by the expert panel members, and supported by the CAIRS-APW algorithm and ANFIS technology. It is assumed that, at this stage, that the user has reviewed the assessment results submitted by the assessors, which typically comes with a laundry-list of recommendations. The list often includes too many recommendations to select from, and with no clear way-forward or action plan, which leaves the user requiring one last step of work, that would actually recommend a clear and concise action plan for the selected assessment area.

The process starts with the user editing the invitation email for an expert panel of subject matter experts (possibly selecting both internal and external members) 173, and sending them the email invitations 174-175. The email invitations 174-175, are either accepted or declined 176. If declined 177, the user is notified via email 178 who can then decide next actions. If accepted, the system sends out the login credentials to the expert panel members 179, using which they log-in and launch the action planning wizard (APW) 180, and review the assessments results, including Ideas for Action (IFAs) collaboratively recommended by assessors 181.

Panel members initially work individually and submit their draft responses on the action plan 182. Once submitted, the system provides them access to the Real Time Collaboration Hub (RTCH) 183, where they interact, collaborate, discuss, and in an iterative manner, attempt to reach a consensus on the action plan 184; thus the action plan is finalized and validated by the expert panel 185, and maintained [updated] over-time.

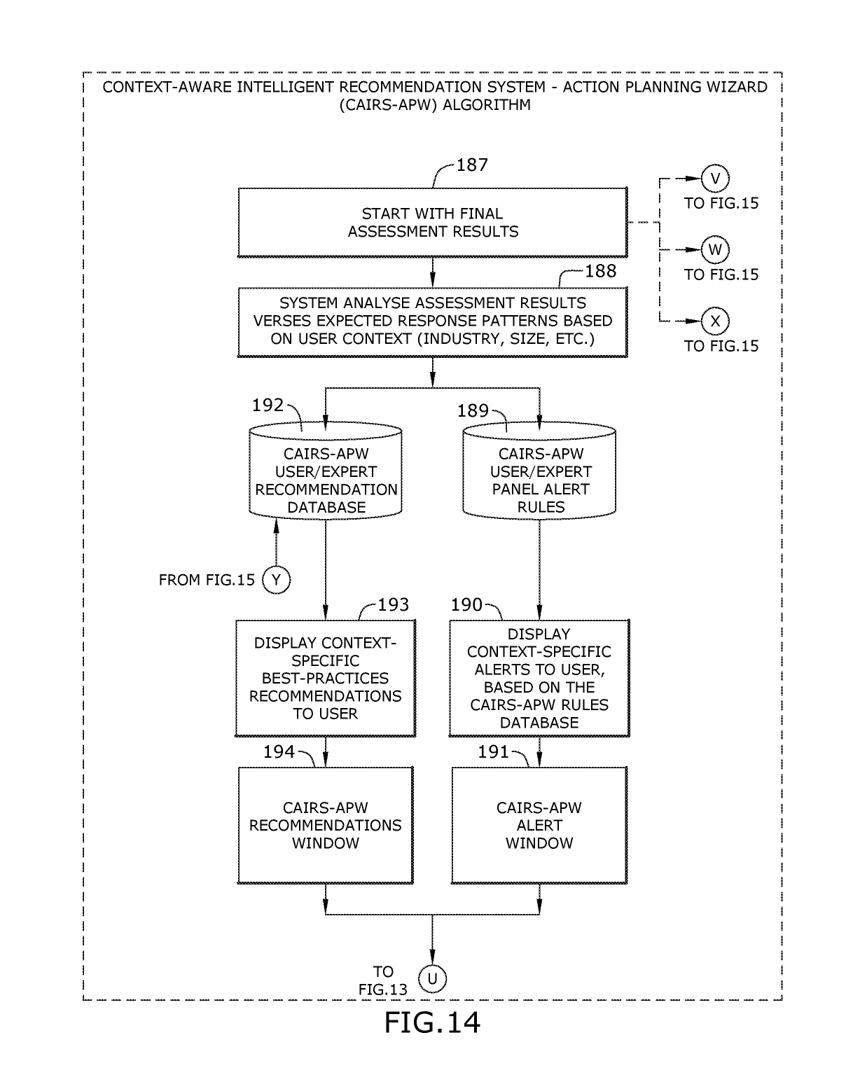

FIG. 14 is a continuation of FIG. 13, and is a flowchart representative of an exemplary depiction for the CAIRS-APW algorithm, which provides dynamically updated recommendations on IFAs and KPIs based on assessor feedback data. In addition, the algorithm provides context-sensitive alerts to the nominated expert panel members based on specific alert rules. The process starts with the final assessment results 187; the system analyzes the assessment results 188, and utilizes the CAIRS-APW database of alert rules 189, in order to display context-sensitive alerts 190 through the CAIRS-APW alerts window 191; while the CAIRS-APW recommendations database 192 displays context-sensitive best practices recommendations on IFAs and KPIs 193 through the CAIRS-APW recommendations window 194.

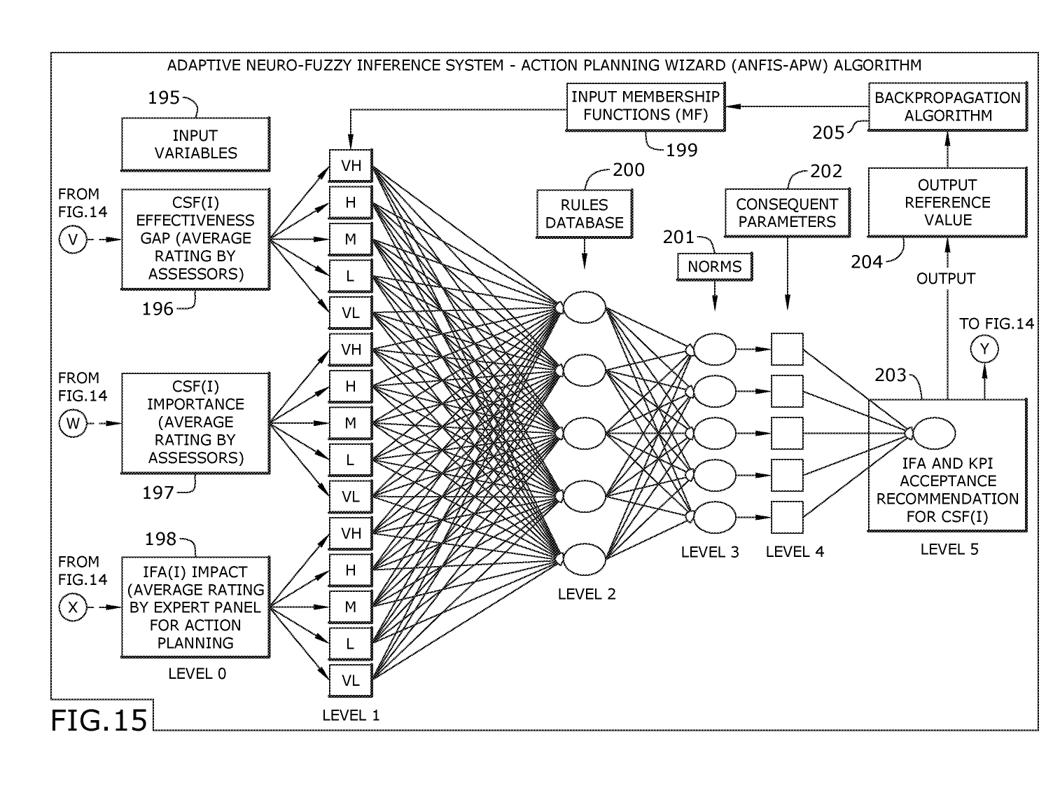

FIG. 15 is a continuation of FIG. 14, and is an exemplary depiction of the process for the Adaptive Neuro-Fuzzy Inference System (ANFIS)-APW algorithm, which dynamically recommends and updates which IFAs ought to be implemented, based on the most recent assessor feedback data. The algorithm starts with input data from the final assessment results 187, and utilizes three input variables 195, including CSF effectiveness gap 196, CSF importance 197, and IFA impact rating by expert panel members 198. The input membership functions 199 provide five fuzzy membership sets (VH, H, M, L, and VL).

The rules database 200, which provides expert contextual intelligence to the ANFIS model. The norms 201 provides the de-fuzzification interface, in order to deliver crisp outputs; while the consequent parameters 202 lead to the output 203, which comes in the form of a recommendation intensity (very low, low, medium, high, very high) regarding the IFAs and KPIs for each CSF within the assessment. Output reference values are provided in the system 204, which is compared to the real outputs, in order to train the neural network through a back-propagation algorithm 205, such that the input membership functions can be appropriately optimized.

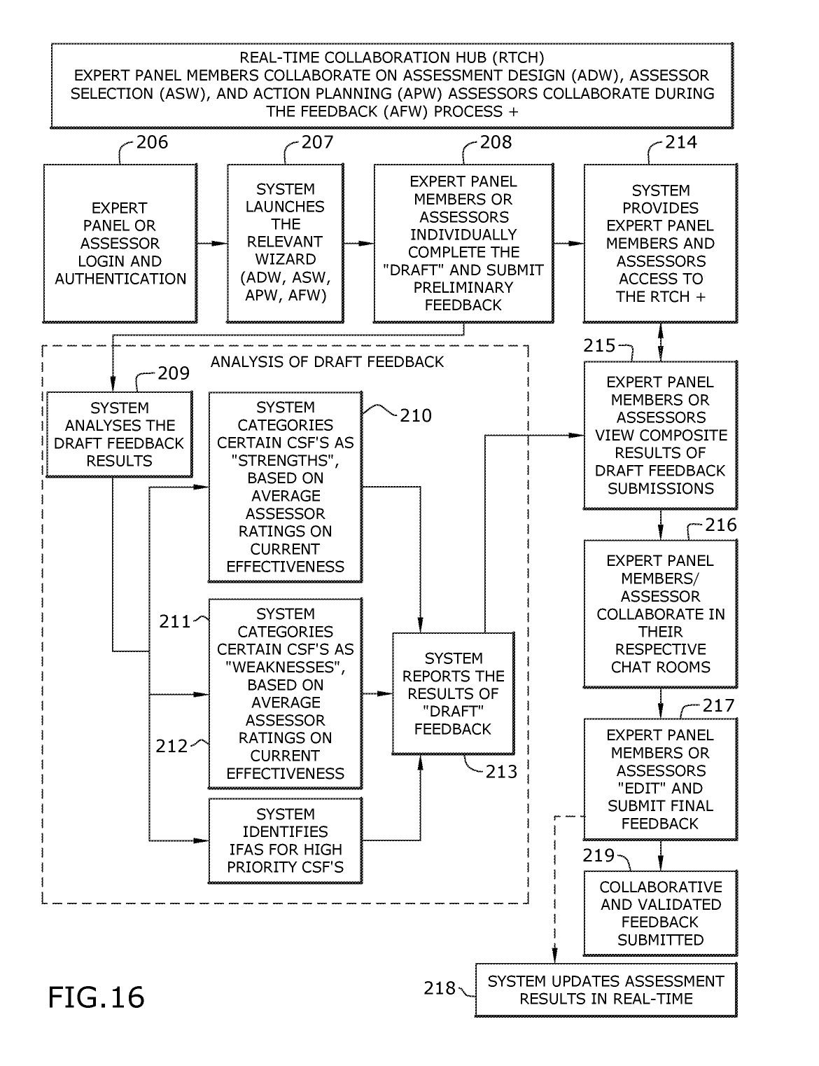

FIG. 16 is a diagram representative of an exemplary depiction of a technical architecture for implementing one embodiment of the Real-Time Collaboration Hub (RTCH); the RTCH supports real-time interactions among members of specific expert panels, and also among nominated assessor groups, and joining the RTCH within a specific panel or assessor group is by invitation only. The RTCH process starts with the respective expert panel members or assessors logging-in 206, which launches the relevant wizard (ADW, ASW, APW, AFW) 207.

The panel members or assessors complete and submit their draft responses 208, and then get access to the RTCH 214, where they can view the preliminary composite results of the draft submissions 215 and also interact with other members or assessors in their respective RTCH 216. After participating in the RTCH, expert panel members or assessors have the option to ‘edit’ their draft submission 217 and submit their final feedback. The system updates the assessment results in real-time 218, which enables the user to track organizational performance on a real-time basis. Thus, the collaborative and validated assessment feedback is submitted 219.

The analysis of draft feedback results 209 comprises identification of CSFs that are classified as strengths, based on average draft ratings by the assessors 210; identification of CSFs that are classified as weaknesses, based on average draft ratings by the assessors 211; identification of IFAs for high priority CSFs 212; and summarization of draft feedback 213.

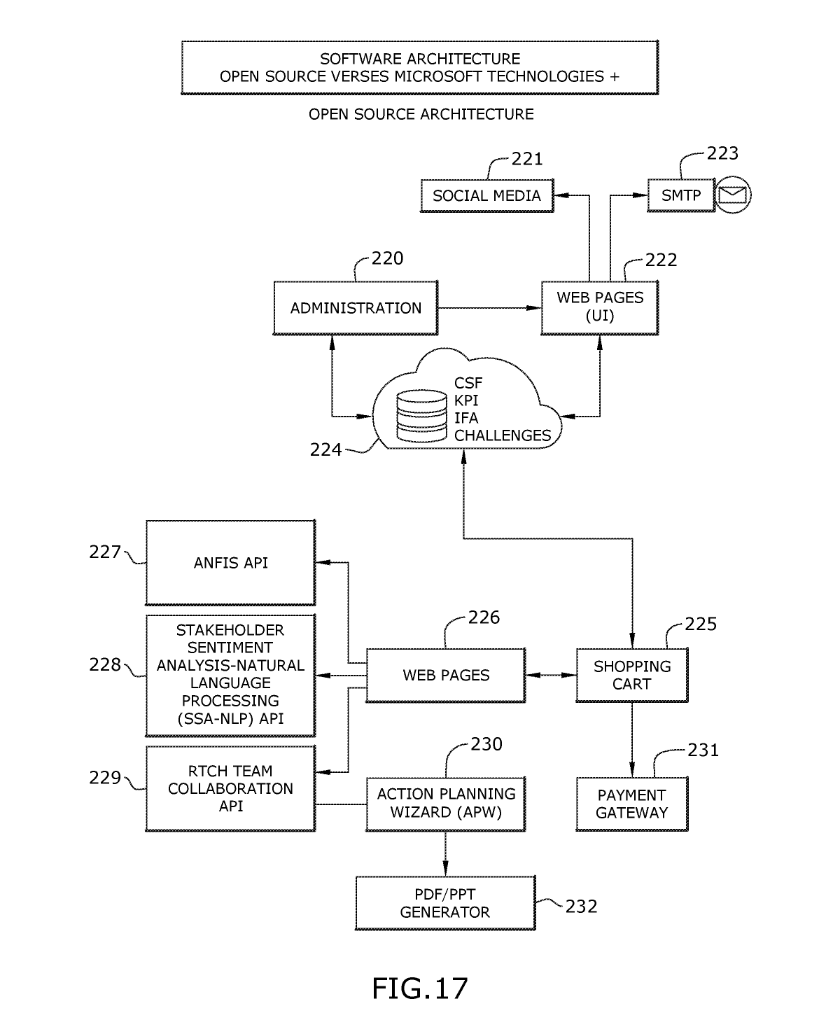

FIG. 17 is a diagram representative of an exemplary framework for developing an integrated Open Source Architecture for developing the UEPMAP software. The open source architecture has an admin section 220, which enables the software administrator manage databases 224, hosted in the cloud. The web pages 222 represent the user interface, which connects with social media 221 sites or services. The web pages also connect to Simple Mail Transfer Protocol (SMTP) 223, which is an internet standard for electronic mail (email) transmission, used for system generated emails to assessors and expert panel members. Web Pages 226 also connect to third party Application Programming Interfaces (APIs), such as ANFIS API 227, Stakeholder Sentiment Analysis—Natural Language Processing (SSA-NLP) API 228, and RTCH team collaboration API 229, which is connected to the APW 230, which in turn is linked to the PDF or PowerPoint (PPT) results generator 232. The Web Pages 226 are connected to the shopping cart 225, which is in turn connected to the payment gateway 231.

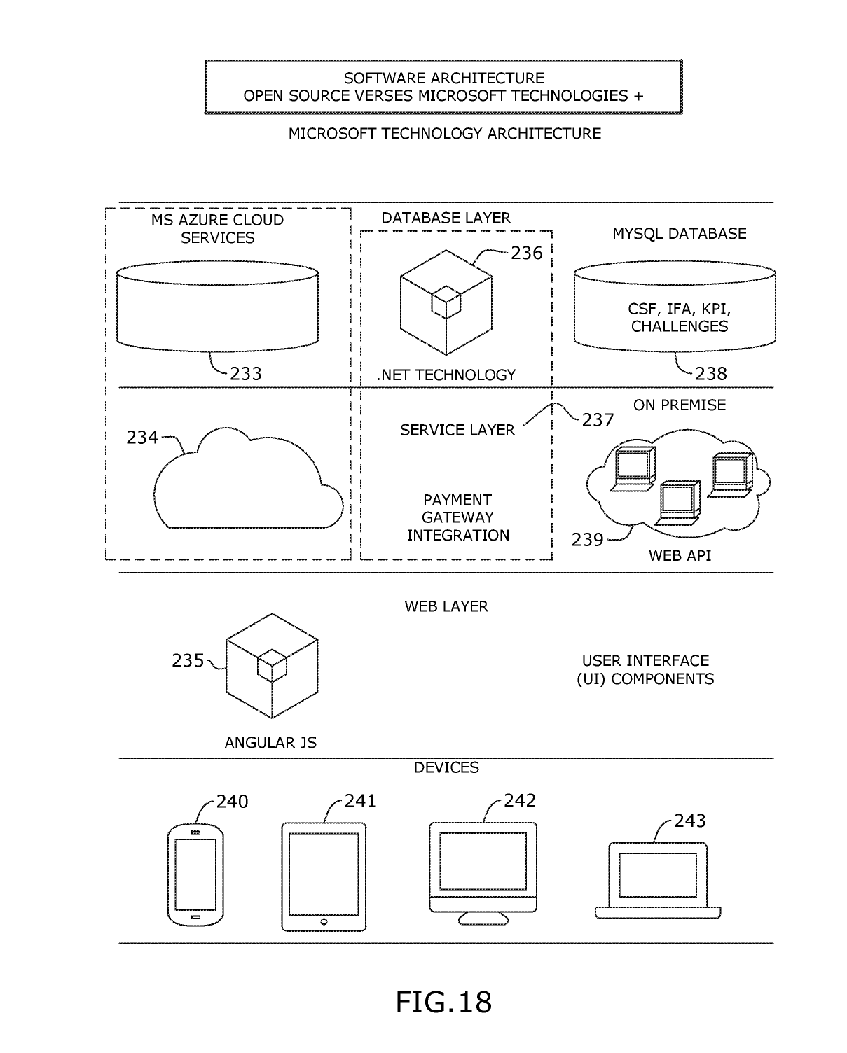

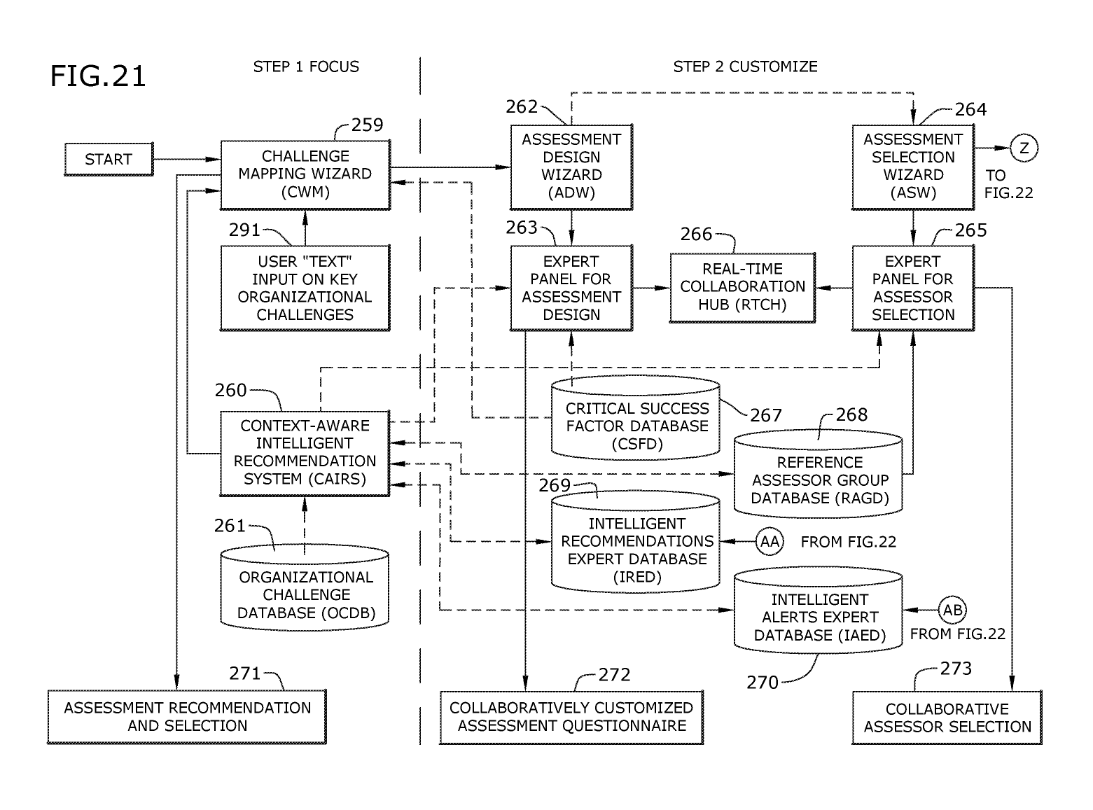

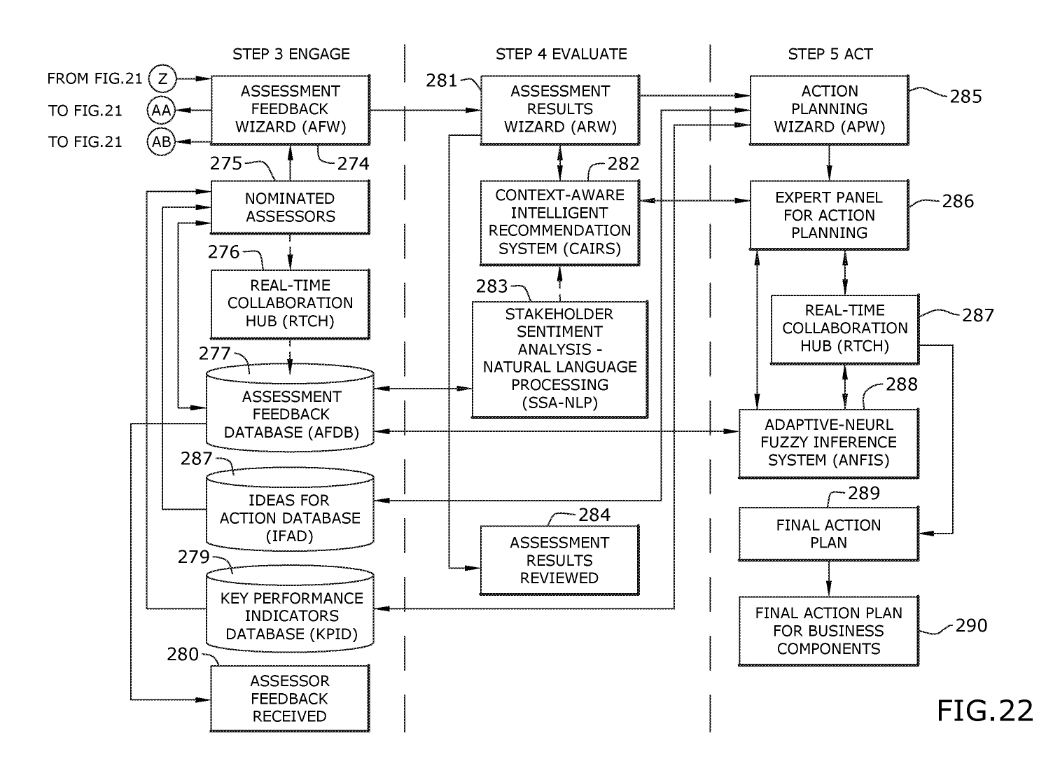

FIG. 18 is a diagram representative of an exemplary depiction of a implementation of the UEPMAP software using Microsoft Technology Architecture, supported by three systems layers viz. database, service, and web; that support a variety of devices to be used with the system 240-243. The database layer is supported by the Microsoft Azure cloud services 233, .NET technology 236, and MySQL database 238; the service layer is supported by cloud infrastructure 234, payment gateway integration 237, and on-premise WebAPIs 239. The Web layer utilizes Angular JavaScript 235, which provides a framework for client-side model-view-controller (MVC) and model-view-view-model (MVVM) architectures, along with components commonly used in rich internet applications. The software architecture can be utilized as a Unified Enterprise Performance Management Application Platform (UEPMAP) through integrating design, implementation, and deployment of the system, leveraging a framework-based approach represented by the 5-step assessment implementation process, which serves as the reference architecture (see FIG. 21-22).

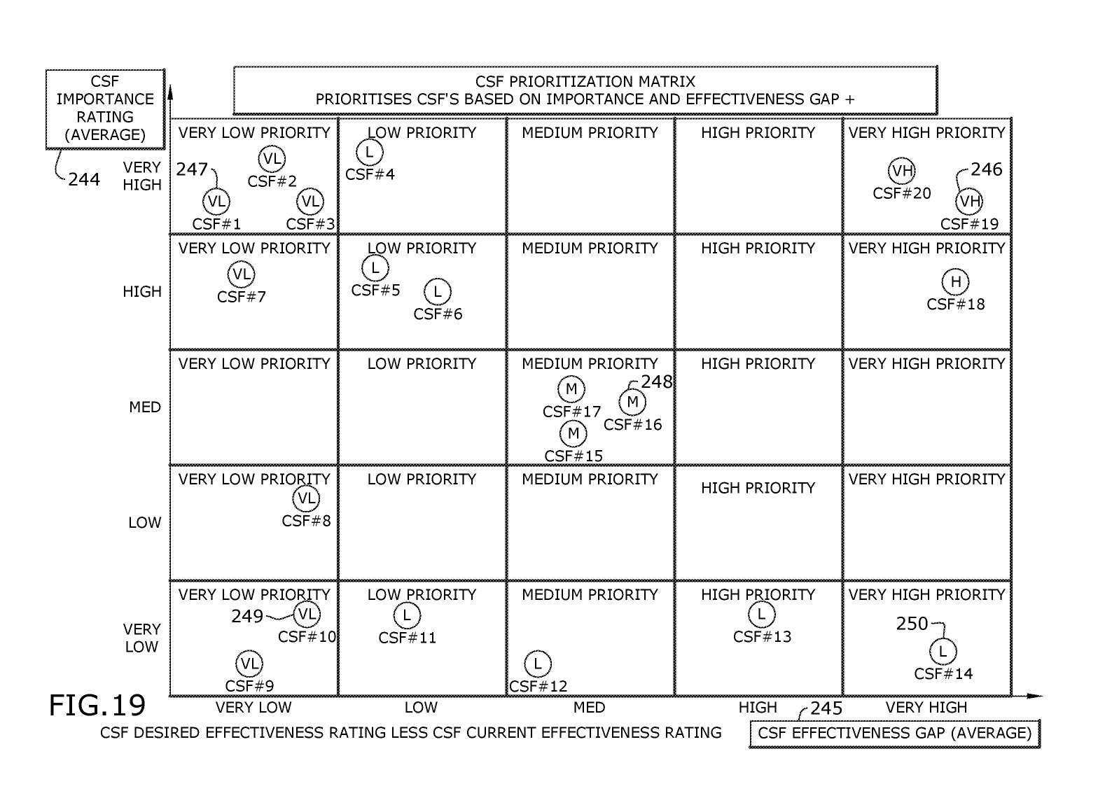

FIG. 19 is a diagram representative of an exemplary depiction of a real-time CSF Prioritization Matrix presented as part of an assessment report. In one embodiment; the real-time CSF Prioritization Matrix prioritizes Critical Success Factors (CSFs) according to its urgency for required action, and is real-time in nature, i.e., when assessors update their assessment ratings dynamically and in an asynchronous manner, the real-time CSF Prioritization Matrix dynamically updates itself. On the horizontal axis is presented the CSF effectiveness gap 245, defined as CSF desired effectiveness rating less CSF current effectiveness rating for each CSF in the 360 feedback survey. Ratings are composite average ratings from the assessors. On the vertical axis is placed the average CSF importance rating 244 by the assessors.

In the 5×5 real-time CSF Prioritization Matrix are placed each CSF based on its importance and effectiveness gap ratings. For example, 20 sample CSFs that are numbered from 1-20 are depicted in the diagram. CSFs that have received an average rating of ‘Very High’ in effectiveness gap implies that the organization is under-performing in these CSFs in terms of effectiveness. However, when these CSFs are also rated as ‘Very High’ in importance to the organization, they are placed in the ‘Very High’ priority cell 246. CSFs with a ‘Very High’ effectiveness gap but also ‘Very Low’ importance rating are placed as ‘Very Low’ 249 in the Prioritization Matrix. CSFs that are rated ‘Medium’ in effectiveness gap and importance 248 are rated as ‘Medium’ in Priority. CSFs that are rated as ‘Very High’ in importance, but ‘Very Low’ in effectiveness gap are rated ‘Very Low’ in priority 247, since no incremental action is needed. Finally, CSFs that are ‘Very High’ in effectiveness gap, but ‘Very Low’ in importance are rated ‘Very High’ in priority 250. The real-time CSF Prioritization Matrix thus enables the user to quickly identify which CSFs the organization ought to focus on, based on their relative importance and effectiveness gap.

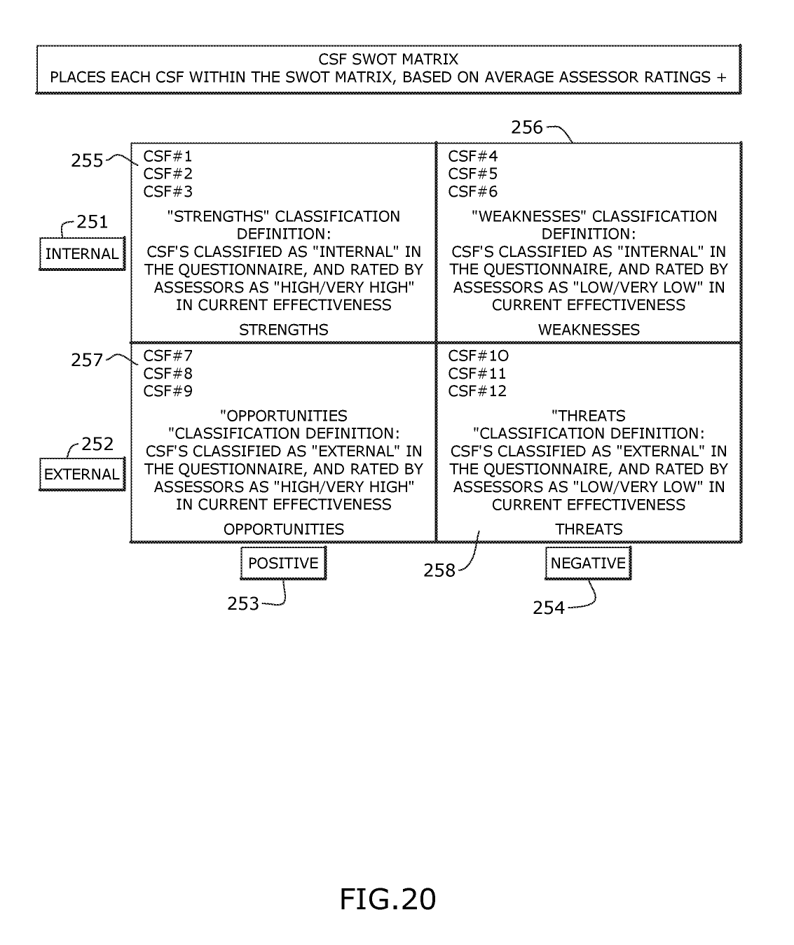

FIG. 20 is a diagram representative of an exemplary depiction of a real-time CSF SWOT Matrix presented as part of an assessment report in one embodiment; an ‘internal’ factor 251 is defined as Critical Success Factors (CSFs) that are primarily internal in nature, i.e., internal to the organization. An ‘external’ factor 252 is a CSF that has significant dependencies with the external environment, i.e., external to the organization. A ‘positive’ factor is a CSF that has received an average assessor rating of ‘High/Very High’ 253, while a ‘negative’ factor is a CSF that has received an average assessor rating of tow/Very Low′ 254. The real-time CSF SWOT Matrix classifies CSFs into one of four quadrants of the real-time CSF SWOT Matrix, based on a 2-stage nested classification methodology.

In the first stage of the nested classification method: CSFs are classified within the CSF database as either an internal factor or an external factor. For example, training and development of employees is typically an internal issue for an organization, and therefore, a CSF related to it would be classified as an ‘internal’ factor in the real-time SWOT matrix; whereas managing regulatory risk relates to the external regulatory environment, and would thus be classified as an ‘external’ factor in the real-time SWOT matrix.

In the second stage, once CSFs have been classified as internal or external in nature, they are then placed into positive or negative categories based on assessor feedback on their ‘current effectiveness’. CSFs #1, #2, and #3 have been classified as ‘Strengths’ for the organization or its business component under assessment because these CSFs are classified as internal to the organization and have received a ‘High/Very High’ effectiveness rating from assessors 255.

CSFs #4, #5, and #6 have been classified as ‘Weaknesses’ for the organization or its business component under assessment because these CSFs are classified as internal to the organization but have received a tow/Very Low′ effectiveness rating from assessors 256. CSFs #7, #8, and #9 have been classified as ‘Opportunities’ for the organization or its business component under assessment because these CSFs are classified as external to the organization and have received a ‘High/Very High’ effectiveness rating from assessors 257. Finally, CSFs #10, #11, and #12 have been classified as ‘Threats’ for the organization or its business component under assessment because these CSFs are classified as external to the organization and have received a tow/Very Low′ effectiveness rating from assessors 258. Thus, with the help of the real-time CSF SWOT Matrix, organizations are able to get a snapshot picture of its CSFs categorized as weaknesses and threats that need to be enhanced with incremental actions and/or initiatives.

FIG. 21 is a diagram representative of an exemplary depiction of a ‘systems architecture view’ of the UEPMAP system's five-step assessment process and the internal workings of the intelligent 360 degree business performance assessment and action planning methodology and process, presented as part of its systems architecture; and covers step 1 (Focus) and step 2 (Customize). A Challenge Mapping Wizard 259 presents the Assessment Recommendation(s) 271 based on user input 291, which is supported by a ‘Context-Aware Intelligent Recommendation System (CAIRS)’ 260, and the CAIRS is, in turn, supported by the Organizational Challenge Database (OCDB) 261. The outcome of Step 1 (Focus) is the selection of the correct organizational assessment, based on key business challenges.

In Step 2 (Customize), the Assessment Design Wizard (ADW) 262 is utilized by the nominated expert panel members for assessment design 263; while the Assessor Selection Wizard 264 is utilized by the nominated expert panel members for assessor selection 265. Both panels utilize the RTCH 266, in order to collaborate and interact during their assessment design and assessor selection processes respectively; supported by the CAIRS 260 which draws data from the CSFD 267, RAGD 268, IRED 269, and IAED 270 databases; the output of Step 2: (a) collaboratively customized assessment questionnaire 272, and (b) collaborative assessor selection 273.

FIG. 22 is a continuation of FIG. 1, and is a diagram representative of an exemplary depiction of a ‘systems architecture view’ of the UEPMAP five-step assessment process. It also depicts the internal workings of the intelligent 360 degree business performance assessment and action planning methodology and process, presented as part of its systems architecture; and covers step 3 (Engage), step 4 (Evaluate), and step 5 (Act).

In Step 3 (Engage), the Assessment Feedback Wizard (AFW) 274 is used by the Nominated Assessors 275, who utilize the Real-Time Collaboration Hub (RTCH) 276, to finalize their feedback ratings. The related structured data (numerical ratings) and un-structured data (text feedback) are stored in the AFDB 277; both the IFAD 278 and KPID 279 support the nominated assessors in providing assessment feedback; with the output of Step 3 being that the assessor feedback data is received in the system, as intended 280.

In Step 4 (Evaluate), the user reviews the assessment results 284 utilizing the Assessment Results Wizard (ARW) 281; which, in turn, is supported by the CAIRS 282; while the unstructured text input data submitted by the assessors are analyzed using Stakeholder Sentiment Analysis and Natural Language Processing (SSA-NLP) technology 283. Thus, step 4 enables the user to gain an in-depth understanding of both the structured and unstructured assessor feedback in the selected business component or assessment area.

Finally, in Step 5 (Act), the user selects an expert panel for action planning 286, which utilizes the Action Planning Wizard (APW) 285. The expert panel reviews the assessment results and collaborates with each other through the RTCH 287. The expert panel is supported by the Adaptive Neural Fuzzy Inference System (ANFIS) 288, which takes input from the Assessment Feedback Database (AFDB) 277, thus helping the expert panel decide on the right actions to be undertaken by the organization for each Critical Success Factor (CSF); as part of the overall Action Plan 289, 290.

As noted above, the decomposition and mapping of the performance of specific business components using the UEPMAP-based intelligent 360 degree feedback system enables dynamic, real-time, and collaborative insights into business performance and in managing the operation of those business components. As used herein, a ‘business component’ may be an organizational sub-division of a company or enterprise such as ‘internal functions’. A business component also may be a ‘business process’ within an enterprise that may be analyzed as an independent operation within or across functional perspectives.

In one embodiment, for example, a software tool may be provided on a laptop or desktop computer for use by a business consultant or business manager (user or assessment owner), who is responsible for the performance of a business component. The user may start with the first step (focus: select the assessment to be carried out, based on existing or potential organizational challenges) of the five steps of the assessment process. The system will guide the user through all five steps of the assessment process, including: communicating with expert panel members and assessors; generating customized questionnaires; enabling real-time collaboration among expert panel members; supporting decision-making by making intelligent recommendations and providing alerts; executing the required calculations and generating assessment results reports on the display of the laptop for review by the user. The decomposition of business component performance by assessor group, by context, and by critical success factors may be displayed in graphical hierarchical maps that provide powerful depictions of the effectiveness of critical success factors or drivers of performance for business components, which may have direct or indirect impact on the future performance of the selected business component(s).

In another embodiment, the program executing the calculations may be resident on computer-readable medium in a server in communication with a privately accessible data communication network, such as the internet or a Wide Area Network (WAN). The program may be accessed through a computer having a browser based interface to implement the same scenario identified above, or scenarios identified below.

Using the above software tool implementing the method of this invention, one may quickly identify business component performance, strengths and weaknesses, and ideas for action, based on collaborative business intelligence, and track real-time performance, focusing on critical success factors that drive the performance of the selected business component(s) in real-time. The identified components may be candidates for further analysis to determine whether additional initiatives ought to be undertaken to improve their performance. The software tool may include a library of critical success factors (CSFs), ideas for action (IFAs), key performance indicators (KPIs), and organizational challenges, associated with each business component. Such solutions may be displayed or included in a real-time dynamic reports generated that describes the identified underperforming component and dynamically updated effectiveness ratings and trend-charts for critical success factors in order to achieve benchmark or other target performance.

In yet another embodiment, the invention may be implemented in an enterprise as part of the business management software. A computer in communication with other financial or operating performance management software that may interact with the plurality of business components. The performance data derived from the invention may be manipulated to correspond with business components according to a map of business components identified as driving current or future value of the business. The performance data may then be analyzed in accordance with this invention to determine and display the expected performance, driven by the actual performance. Such data may be graphically displayed in a hierarchical map, or in the form of an executive dashboard. The actual performance data may be displayed along side with target values for various business component values. Colors, such as green, yellow, or red, for example, may be used to identify the relative performance, such as above, below, or greatly below target values assigned to individual business components. Additionally, acceptable tolerances for each business component target value may be established and reflected in the display. Such tools may be useful when integrated as monitoring tools into the business performance management frameworks.

In still another embodiment, the invention may be implemented in the form of a best practices data provider. A database containing industry specific critical success factors, key performance indicators, ideas for action, and organizational challenges may be in communication on a publicly accessible network. For a fee, users may access such data and, using the software tools on their own systems or on a server dedicated to this database, the users may map the components of the database to their own business components or challenges. Also, the users may focus on a specific industry to determine industry benchmarks of component values. Those component benchmarks may be applied to generate assessment results used for comparison purposes in making decisions on new business initiatives within a specific company. Alternatively, the benchmarks may be used for comparison to identify which business components within a company are underperforming vis-à-vis competitors, to enable business mangers to determine which business components require additional resources to maintain competitive performance levels.

In an alternative embodiment, the invention may be implemented in the form of target setting, forecasting, and budgeting tools in which targets are selected at a high level of management through a process of strategic planning to select targets based on a combination of values, such as business component effectiveness scores. In one embodiment, computer simulations of, inter alia, increased resource flows expected by the target strategies. These targets or initiatives may then be flowed down to the various levels of management within business components, budgets may be constructed around those target strategies or initiatives, and the budgets may be consolidated and flowed upward. Alternatively, or additionally, the system may be used to increase business component performance levels by improving internal skills and competencies or abilities through the use of graphical representations of performance metrics of similarly situated companies in order to identify realistic value enhancing business strategies as goals for the organization.

In still another embodiment, the invention may be implemented in a system for automatically examining a company's internal performance by business component.

In view of the shortcomings noted above of conventional 360 feedback systems to communicate an accurate picture of a company's current performance, or that of its respective business components, as well as the management of the critical success factors of future performance, yet another embodiment of the present invention is provided. The invention may be advantageously implemented to enhance the quality of stakeholder relationships such as customer relations, investor relations, and public relations, based on direct feedback and insights provided by the key external and internal stakeholders, which are further analyzed using advanced techniques such as sentiment analysis, intelligent recommendation systems, fuzzy inference systems, and real-time collaboration by the stakeholders themselves.

Based on the teachings described herein, others of ordinary skill in the art will appreciate other applications of the system, apparatus and methods in accordance with this invention. Accordingly, it is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for conducting real-time ongoing collaborative assessments of the performance of a plurality of selected business components within an organization, utilizing a scalable, customizable, and context-aware Unified Enterprise Performance Management Application Platform (UEPMAP) configured to perform static and dynamic real-time and asynchronous business intelligence gathering, analysis, action planning, performance reporting, and ongoing performance management comprising the steps of:
providing a context aware intelligent recommendation system (CAIRS) challenge mapping wizard (CMW) configured to receive an organizational challenge input from a user and map the organizational challenge input to one or more of the plurality of selected business components;
providing a CAIRS-assessment design wizard (ADW) configured to invite one or more expert panel members for assessment design, enable real-time collaboration between the expert panel members, and customize a best practices questionnaire template by selecting one or more relevant critical success factors (CSFs) corresponding to the plurality of selected business components, where CSF selections and one or more new CSF inputs are received from the expert panel members collaboratively connected to the CAI RS-ADW, supported by a Real-Time Collaboration Hub (RTCH);
providing a CAIRS-assessor selection wizard (ASW) configured to invite one or more members to an assessor selection expert panel, enable real-time collaboration between the assessor selection expert panel members, and receive collaborative nominations of one or more individual assessors selected by the assessor selection expert panel members;
providing a CAIRS-assessment feedback wizard (AFW) configured to send an email invitation to a group of one or more nominated assessors, enable the one or more assessors to collaborate with each other utilizing the RTCH, input assessment feedback data, and receive collaborative feedback from the group of assessors on the effectiveness of the selected CSFs for the selected business component being assessed;
providing a CAIRS-assessment results wizard (ARW) configured to perform an analysis of the assessment feedback data, including at least one of a quantitative rating and a qualitative rating of CSF effectiveness through a Stakeholder Sentiment Analysis (SSA), classifying CSFs as one of a strength or a weakness based on the analysis, and recommending one or more Ideas for Action (IFAs) and one or more Key Performance Indicators (KPIs) based on the assessor feedback data, presenting a business component effectiveness result organized by one or more of an assessor group, an assessment context, and the CSF; and
providing a CAIRS-action planning wizard (APW) configured to invite one or more members to an action planning expert panel, enable real-time collaboration between the action planning expert panel members, supported by an Adaptive Neural Fuzzy Inference System (ANFIS) configured to prioritize selected IFAs based on the assessment feedback data, the CAIRS-APW and configured to define an action plan for the selected business component based on inputs received from the action planning expert panel.

2. The computer-implemented method of claim 1, further comprising:
providing a real-time interface for one or more Key Persons Accountable (KPAs) to review the action plan and to input an update of one or more actions taken to implement the IFAs on an ongoing basis,
notify assessors of the actions taken, and
providing a real-time interface for the assessors to update one or more of the qualitative rating and quantitative rating of CSF effectiveness based on the actions taken.

3. The computer-implemented method of claim 1, further comprising:
assigning a specific element of the action plan to a Key Person Accountable (KPA),
providing a KPA interface to receive real-time task implementation updates from the KPA related to the IFAs assigned, in order to track an action plan performance result against an action plan target in real-time;

4. The computer-implemented method of claim 3, further comprising:
receiving ongoing assessor CSF effectiveness rating inputs,
providing a real-time dynamic assessment results update for business component CSF effectiveness, based on ongoing the task implementation updates submitted by the KPA; and dynamically updating the assessment result.

5. The computer-implemented method of claim 4, wherein the assessment result is based on one or more of a current level of effectiveness of CSFs, a desired level of effectiveness of CSFs, and a level of importance of each CSF within the business component.

6. The computer-implemented method of claim 5, further comprising:
presenting a report comprising one or more of: a real-time CSF prioritization matrix; a real-time CSF SWOT matrix; and an ideas for action (IFA) matrix; including a rating of the impact of each IFA within each CSF.

7. The computer-implemented method of claim 1, further comprising:
determining which CSFs have the highest priority for action, based on their effectiveness and importance ratings, represented in the real-time ‘CSF Prioritization Matrix’ for each business component, by developing a CSF prioritization index represented by the product of three factors: (1) an average CSF importance rating, (2) a CSF effectiveness gap, represented by the average difference between the desired level of effectiveness of the CSF and the CSF current effectiveness rating;
and (3) an average sentiment analysis score from the assessors relating to the CSF.

8. The computer-implemented method of claim 1, wherein the reports further include:
displaying the performance results of the business component segregated by assessor groups, comprising one or more of: customers, business partners, senior executives, mid-level managers, junior employees; shareholders, creditors, suppliers, or other stakeholders, and
decomposing the performance results into a plurality of assessment contexts, including one or more of a people and leadership context; an analytics and insights context; a strategy and planning context; an execution and process context; and a performance and results context.

9. The computer-implemented method of claim 1, further comprising:
an Adaptive Neural Fuzzy Inference System (ANFIS), configured to evaluate assessor feedback data on an IFA impact rating for each CSF, combined with a CSF importance rating and a CSF effectiveness ratings, in order to prioritize recommended IFAs into a high, a medium, and a low priority category; to facilitate the selection of IFAs to be recommended for implementation by action planning expert panel members.

10. A computer-implemented method comprising:
receiving, into a memory coupled to a processor, user-entered un-structured data about challenges facing one of an organization or a business component within the organization;
displaying, in a display coupled to the processor, one or more relevant business components or organizational assessments that may be relevant in supporting the organization in addressing the challenges described.
employing a CAIRS-CMW comprising a text-matching algorithm configured to identify one or more keywords within the a corpus of the unstructured data entered to describes organizational challenges,

11. The computer-implemented method of claim 10, further comprising:
receiving, into a non-transitory memory coupled to a processor, user-entered real-time assessment feedback data that is unstructured and textual, representing assessor opinions of an assessor on the effectiveness of CSFs within business components
grouping the real-time assessment feedback data by one or more of an assessor group, a stakeholder group, and an assessment context including one or more of: (a) people and leadership, (b) analytics and insights, (c) strategy and planning, (d) execution and process, and (e) performance and results; and
analyzing the un-structured feedback data submitted by the assessor utilizing a Natural Language Processing (NLP) and a Sentiment Analysis module configured to deliver a sentiment classification and a related score for a corpus of the feedback textual data.

12. The computer implemented method of claim 11 further comprising:
applying a Stakeholder Sentiment Analysis (SSA) to the feedback data; the SSA providing a sentiment polarity analysis to determine whether the corpus of the feedback data is positive, negative, or neutral in its overall sentiment, based on a semantic analysis.

13. The computer-implemented method of claim 12, further comprising:
receiving one or more of a user-entered structured or a numerical assessment feedback data, comprising an individual assessor rating on a current effectiveness, a desired effectiveness, and an importance for each CSF selected in the questionnaire for the selected business component; and selecting related an Idea for Action (IFA), and a Key Performance Indicator (KPI) along with the importance ratings for a plurality of Critical Success Factors (CSFs), and
determining the priority levels of the IFAs and KPIs utilizing an Adaptive Neural Fuzzy Inference System (ANFIS).

14. The computer implemented method of claim 13, wherein the ANFIS is configured to analyze one or more crisp input variables, including: an Average CSF effectiveness gap rating, an Average CSF importance rating, and an Average IFA impact rating for each CSF evaluated.

15. The computer implemented method of claim 14, wherein the ANFIS is further configured with a membership function for the crisp input variables that are fuzzy sets; supported by a rules database which generates fuzzy outputs, supported by a de-fuzzification interface, and delivering an IFA and a KPI prioritization recommendation for each CSF assessed.

16. A computer-implemented method comprising:
receiving, into a non-transitory memory coupled to a processor, contextually specific user-entered data comprising at least one of a vertical industry, a number of employees, an organizational challenge, and assessment feedback result;
providing one or more relevant recommendations and alerts to users throughout an assessment feedback process; the recommendations comprising
a suggested CSF, KPI, and IFA, drawn from an expert rules database during the assessment feedback process utilizing a real-time Context-Aware Intelligent Recommendation System (CAIRS);
the alerts comprising a real-time analysis of assessment feedback data; and highlighting one or more key factors that are outside a normal range of expected values.

17. The computer implemented method of claim 16 further comprising:
contextualizing sensitive data, including both structured and unstructured assessor input data; leveraging the organizational context; and
accessing a best practices database of Critical Success Factors (CSFs), Ideas for Action (IFAs), and Key Performance Indicators (KPIs); expert decision rules based on best practices.

18. A system for conducting real-time ongoing collaborative assessments of the performance of a plurality of selected business components within an organization, comprising:
a machine; and
a program product comprising machine-readable program code for causing, when executed, the machine to perform the method as claimed in claim 1.
